(19) United States
(12) Patent Application Publication
(10) Pub. No.: US 2020/0362174 A1
(43) Pub. Date: Nov. 19, 2020

(54) COMPOUNDS AND METHODS FOR OPTICAL SENSING OF ELECTRICAL ACTIVITY IN BIOLOGICAL SYSTEMS

(71) Applicant: UNIVERSITY OF CONNECTICUT, Farmington, CT (US)

(72) Inventors: Leslie M. LOEW, West Hartford, CT (US); Ping YAN, Avon, CT (US); Corey ACKER, West Hartford, CT (US)

(21) Appl. No.: 16/961,324

(22) PCT Filed: Jan. 11, 2019
(86) PCT No.: PCT/US2019/013311

§ 371 Date: Jul. 10, 2020

Related U.S. Application Data
(60) Provisional application No. 62/616,744, filed on Jan. 12, 2018.

(51) Int. Cl. C09B 69/00; C09B 11/08; C09B 23/00

(52) U.S. Cl. CPC C09B 69/00; C09B 23/00; C09B 11/08

(57) ABSTRACT

Disclosed are tethered chromophore compositions comprising a membrane-spanning tether. The compounds can include covalently tethered fluorophore-quencher combinations useful for measuring action potentials and other fast electrical events in cells and tissues.

### CROSS REFERENCE TO RELATED APPLICATIONS

This application claims the benefit of U.S. Provisional Application No. 62/616,744 filed Jan. 12, 2018, which is hereby incorporated by reference in its entirety.

### STATEMENT OF GOVERNMENT SUPPORT

This invention was made with government support under Grant #EB001963 awarded by the National Institutes of Health. The government has certain rights in the invention.

### FIELD OF INVENTION

The disclosure contained herein is in the general field of dyes and methods for measuring fast electrical events in cells and tissues.

### BACKGROUND

Voltage sensitive dyes (VSDs) are used for in vitro drug screening and for imaging of patterns of electrical activity in tissue. Wide application of this technology depends on the availability of sensors with high sensitivity (percent change of fluorescence per 100 mV), high fluorescence quantum yield, and fast response kinetics. Currently the most popular cell-based drug screening platform involves a two-component FRET (Fluorescence Resonance Energy Transfer) assay where one dye is confined to the outer surface of the cell and the second can traverse the cell membrane in response to a change in membrane potential. The basis for this known method is that the first dye will fluoresce only when it is distant from the second dye because of a mechanism known as FRET; therefore its fluorescence will go up in the depolarized state, i.e., when the second dye moves across the membrane and away from the first dye. Molecular Devices sells an instrument (“FLIPR”) with proprietary reagents for channel drug screening. Based on the available product description, it is believed that the two reagents/components are based on a two-component FRET voltage-sensitive dye (VSD) pair.

The major problem with this known technology is that the two dyes must be within ˜5 nanometer (nm) of each other for fluoresence quenching by FRET to occur. This requires a very high density of dyes on the membrane, so high that direct interaction of a dye with the channel molecules often leads to artifacts, including interference with drug binding.

There remains an umet need for dye-based compounds and methods for screening and imaging that are fast enough to follow action potentials in real time.

### SUMMARY

One embodiment is a compound of Formula (1) FP-T-Q, and biologically acceptable salts thereof, wherein FP is a first chromophore; Q is a second chromophore; and T is a membrane-spanning tether.

In another embodiment, a method for ion channel drug screening comprises using one or more of the compounds of Formula (1).

In another embodiment, a method for screening drugs for cardiac toxicology comprises using one or more of the compounds of Formula (1).

In another embodiment, a method for non-invasive imaging of electrical activity in human brain and heart comprises using one or more of the compounds of Formula (1).

In another embodiment, a method of photoacoustic imaging for recording electrical activity deep in tissues comprises using one or more of the compounds of Formula (1).

### DRAWINGS

Referring now to the figures, which are exemplary embodiments, and wherein the like elements are numbered alike:

FIG. 1 is an illustration of two component chromophores built into a single molecule by linking them with a long membrane-spanning tether. In the resting state a fluorophore (vertical ellipse) is quenched by a tethered anionic chromophore (circle enclosing a negative sign). During depolarization of a membrane the acceptor component of the tethered dye pair moves to the opposite side of the membrane from the fluorescent donor component; quenching is reduced and fluorescence increases.

FIG. 2A is a synthetic scheme for the preparation of tethered fluorophore-quencher VSD-PY6084.

FIG. 2B illustrates a modular strategy that can be used to synthesize tethered fluorophore-quencher dyes with tethers that are tunable both in length and hydrophilic/hydrophobic balance.

FIG. 3. (A) Setup of hemispherical lipid bilayer apparatus (not to scale). The resistance for the bubble is around 1MΩ. The dye solution was loaded to the internal side of the bubble (diameter ˜1 mm). A MATLAB program controls the output voltage, stepper motor for monochromator, and signal acquisition. (B) Averaged fluorescence from Di-4-ANEPPS (n=100) and membrane potential on the bubble. The membrane potential was calculated by integrating the current through Ra, and inverted for comparison purpose.

FIG. 4 illustrates the response of PY6210 to a 100 mV depolarizing pulse on the voltage clamped hemispherical bilayer apparatus; the top panel shows the applied voltage and the bottom panel shows the fluorescence response.

FIG. 5 is an exemplary synthesis of red and near infrared VSDs for both photoacoustic (PA) and fluorescence imaging.

FIG. 6. (A) Comparison of voltage sensitivity of TBFQ1 (PY6210), the two-component system Di-4-ANEPPS/DPA and the electrochromic VSD Di-4-ANEPPS. (B) Current recordings in response to voltage steps for the 3 VSD systems.

### DETAILED DESCRIPTION

Disclosed herein are new approaches and methods to measure action potentials and other fast electrical events in cells and tissues, wherein the methods are based on the use of compounds that are covalently tethered fluorophore-quencher combinations (alternatively referred to herein as tethered bichromophoric fluorophore quencher). Novel compounds are also disclosed. The sensitivity of existing fast voltage sensors is limited, by the physical chemistry of their mechanisms, to ˜25% fluorescence change per action potential. The methods and compounds disclosed herein do not have such limitations. Rather, observed responses to action potentials have been characterized by ˜150% or greater changes in fluorescence.

Some preferred embodiments of the disclosed compounds and methods have commercial applications in ion channel drug screening. Other preferred embodiments of the disclosed compounds and methods have commercial applications for possible screening of all drugs for cardiac toxicology. End users include scientists or technicians in R&D departments in the pharmaceutical and biotechnology industries. The compounds will also be used by academic researchers interested in imaging electrical activity in tissue and animal models.

In further preferred embodiments the compounds and methods disclosed herein have utility for non-invasive imaging of electrical activity in human brain and heart; photoacoustic imaging, in particular, could allow for recording electrical activity deep in tissues.

In the general field of the disclosed compounds and methods, there are well established, commercial cell-based ion channel drug screening assays that use two-component systems where the quencher and chromophore are separate molecules. These systems require very high concentrations of the components leading to the possibility of significant artifacts from direct pharmacological effects of the sensor molecules. These assays are also too slow to characterize action potentials, as would be required for toxicology screening applications. The latter are currently achieved with existing single component sensors that have much lower (25%) sensitivity. None of the existing technologies have the sensitivity, response speed, or depth of penetration required for effective noninvasive imaging in animal models or humans.

It is an object of the compounds and methods disclosed herein to increase sensitivity and to reduce artifacts from direct pharmacological effects of sensor molecules in screening assays and imaging.

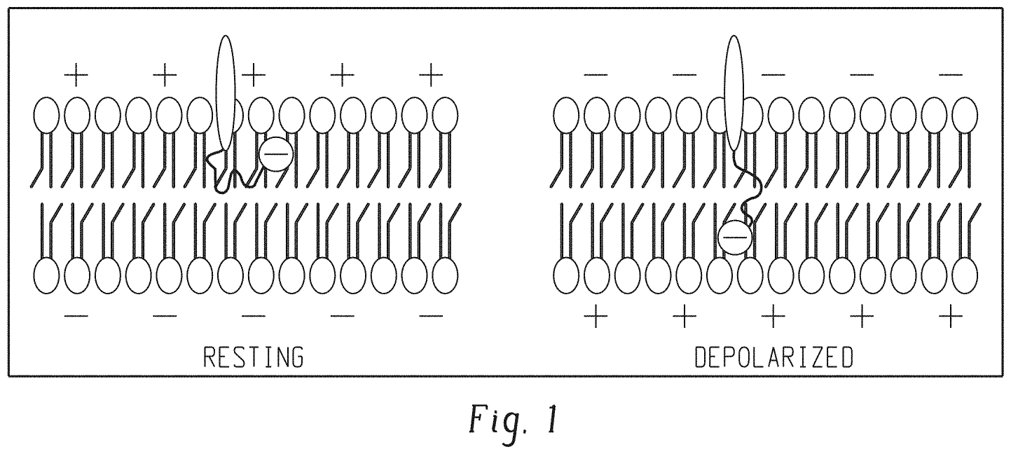

With the novel compounds and methods disclosed herein fluorescent donor and non-fluorescent acceptor FRET pairs are linked together using a membrane spanning tether. In a polarized membrane state, the acceptor will quench the fluorescence of the donor. During depolarization of a membrane (as during an action potential) the acceptor will move to the opposite side of the membrane resulting in reduced quenching by the acceptor and increased fluorescence of the donor (see FIG. 1). By engineering the FRET efficiency one can achieve at least a 150% increase in fluorescence during a 100 mV depolarization, which is equivalent to an action potential.

It is an advantage of the disclosed technology that the response time of the FRET pair will be fast enough to follow action potentials in real time, unlike current two-component drug screening assays. It is a further advantage of the disclosed technology that one can use at least 10-fold lower concentrations of the sensor molecules, thereby reducing the potential for pharmacological artifacts in the measurements.

In the technology disclosed herein, two component chromophores are built into a single molecule by linking them with a long membrane-spanning tether, as depicted in FIG. 1. In the resting state a fluorophore (vertical ellipse) is quenched by a tethered anionic chromophore (circle enclosing a negative sign). During depolarization of a membrane the acceptor component of the tethered dye pair moves to the opposite side of the membrane from the fluorescent donor component; quenching is reduced and fluorescence increases.

In this scheme, there is no need to use high concentrations because the two components are forced to stay within 5 nm of each other by the tether. In fact, one needs to decrease the FRET efficiency so that FRET will only be possible when the two chromophores are on the same side of the membrane (i.e. the Resting state).

In one embodiment, a tethered bichromophoric fluorophore quencher is a compound of Formula (1)

FP-T-Q Formula (1)

and biologically acceptable salts thereof, wherein FP is a first chromophore; Q is a second chromophore; and T is a membrane-spanning tether. As used herein “membrane-spanning tether” means the length of the tether is long enough for FP and Q to reside at the opposite aqueous interfaces of the membrane, specifically the lipid bilayer of a cell membrane. This requires that T be approximately 4 nanometers long or longer. In an embodiment, the first chromophore FP is a fluorophore and the second chromophore Q is a dye compound that quenches the fluorescence of the first chromophore by fluorescence resonance energy transfer (FRET), collisional quenching, charge transfer complex formation, or another quenching mechanism.

The first chromophore (“FP”) is a fluorophore. The FP in Formula (1) can be a fluorescent dye that can be functionalized with a non-permeant sidechain, such as a quaternary ammonium group. Exemplary fluorphores include derivatives of fluorescein, rhodamine, cyanine, hemicyanine and oxonols, and the like. In an alternative embodiment, FP may be a fluorescent protein that can be fixed to one side of the membrane and can have a reactive sidechain to allow for covalent binding to the T-Q moiety. In an embodiment, the first chromophore FP has the structure FP-1

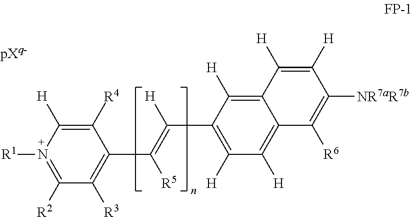

wherein p is 0, 1, or 2; X^{q-} is an anionic counterion having a charge, q, that is 1 or 2; n is 1 or 2; R¹ is an optionally substituted C₁-C₁₂ alkyl; R² is hydrogen, and R is hydrogen or fluorine; or R² and R³ collectively form a divalent —CH═CH—CH═CH— group; R⁴ and each occurrence of R⁵ are each independently hydrogen or fluorine; R⁶ is hydrogen or fluorine or trifluoromethyl; R^{7a} is independently C₁-C₆ alkyl; and R is a bond linking to T, the membrane-spanning tether.

R¹ is an optionally substituted C₁-C₁₂ alkyl, which may be substituted with, for example, hydroxyl, C₆-C₁₂ aryl, C₃-C₁₀ cycloalkyl, C₁-C₁₀ alkyl, halogen, C₁-C₁₀ alkoxy, C₁-C₁₀ alkylthio, C₁-C₁₀ haloalkyl, C₆-C₁₂ haloaryl, pyridyl, cyano, thiocyanato, nitro, amino, C₁-C₁₂ alkylamino, C₁-C₁₂ aminoalkyl, acyl, sulfoxyl, sulfonyl, sulfonate, amido, a quaternary ammonium group, or carbamoyl.

In a further embodiment, when R¹ is substituted is —CH₂CH(OH)CH₂N⁺(CH₃)₂(CH₂CH₂OH); —(CH₂)₃SO₃⁻; —(CH₂)₄SO₃⁻; —(CH₂)₃—N⁺(R⁸)₃ wherein each occurrence of R⁸ is independently C₁-C₆ alkyl or C₁-C₄—SO₃⁻; —(CH₂)₂—N⁺(R⁹)₃ wherein each occurrence of R⁹ is independently C₁-C₆ alkyl or C₁-C₄—SO₃⁻; or —CH₂CH₂OCH₂CH₂OCH₂CH₂OH.

The tethered bichromophoric fluorophore quencher can include one or more counterions, such as X^{q-}, to balance any positive charge(s) on the remainder of the compound (including any charged substituents at R¹). In other words, the total negative charge, p×q, contributed by the anion(s) pX^{q-}, is equal to the net positive charge on the remainder of the compound. Suitable counterions, X^{q-}, include, for example, hydroxide, fluoride, chloride, bromide, iodide, sulfite, sulfate, acetate, trifluoroacetate, propionate, succinate, glycolate, stearate, lactate, malate, tartrate, citrate, ascorbate, pamoate, maleate, hydroxymaleate, phenylacetate, glutamate, benzoate, salicylate, sulfanilate, 2-acetoxybenzoate, fumarate, toluenesulfonate, methanesulfonate, ethanesulfonate, ethane disulfonate, benzenesulfonate, toluenesulfonate, oxalate, malonate, succinate, glutarate, adipate, isethionate, and the like, and mixtures thereof. In some embodiments, X^{q-} is bromide.

In other embodiments, the tethered bichromophoric fluorophore quencher is zwitterionic and includes no counterions, X^{q-}. For example, the can be zwitterionic when R¹ is —(CH₂)₃SO₃⁻ or —(CH₂)₄SO₃⁻.

In an embodiment, the first chromophore is of the structure FP-1 wherein n is 1. In another embodiment, the first chromophore is of the structure FP-1 wherein R², R³, R⁴, R⁵, and R⁶ are hydrogen. In another embodiment, the first chromophore is of the structure FP-1 wherein R^{7a} is methyl. In an embodiment, the first chromophore is of the structure FP-1 wherein n is 1; R², R³, R⁴, R⁵, and R⁶ are hydrogen; and R^{7a} is methyl.

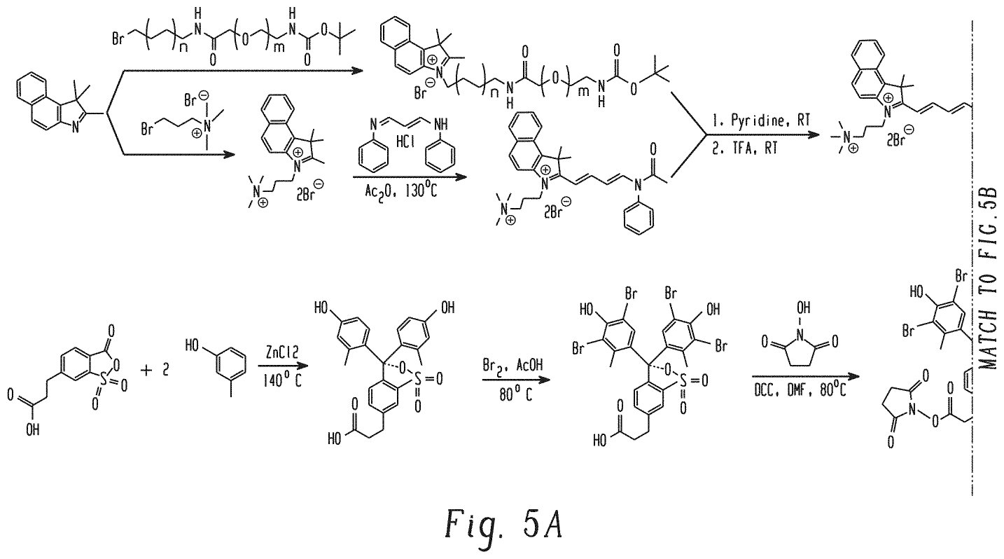

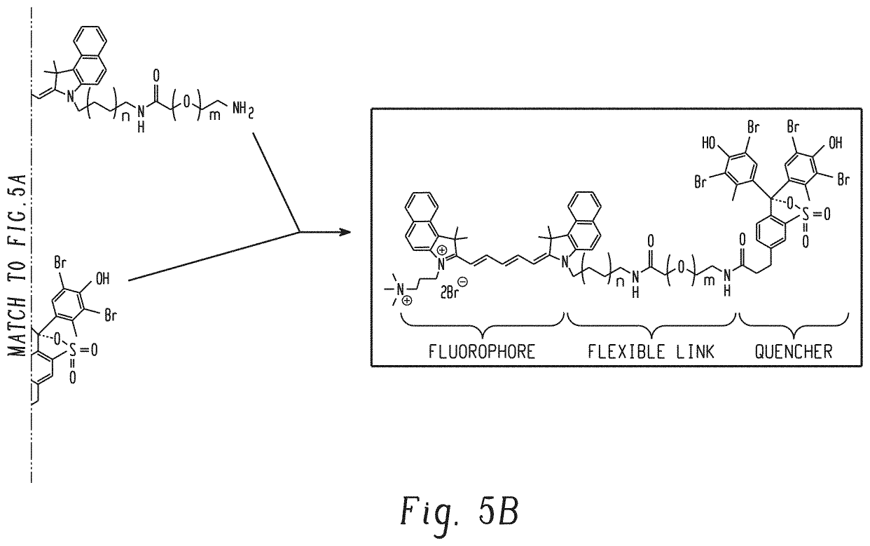

In another embodiment, the first chromophore is a substituted or unsubstituted cyanine dye fluorophore or derivative thereof, including Cy3, Cy3.5, Cy5, Cy5.5, Cy7, and Cy7.5. The “Cy” means ‘cyanine’, and the first digit identifies the number of carbon atoms between the indolenine groups and the suffix.5 is added for benzo-fused cyanines. The cyanine dye fluorophore derivative may be substituted at one of the nitrogen groups of the indolenine group with an optionally substituted alkyl such as R¹ described herein. The cyanine dye can be linked to the membrane-spanning tether through the nitrogen group of the second indolenine group. In an embodiment, the cyanine dye fluorophore is Cy5.5 or a derivative thereof. FIG. 5 illustrates an embodiment with a cyanine derivative fluorophore.

The second chromophore (“Q”) in Formula (1) is a molecule effective for quenching a fluorophore, such as the first chromophore. Q can be any anionic chromophore that is capable of being a FRET acceptor for the partner fluorophore “FP” and is able to rapidly translocate across the membrane. In an embodiment, the second chromophore Q has the structure Q-1

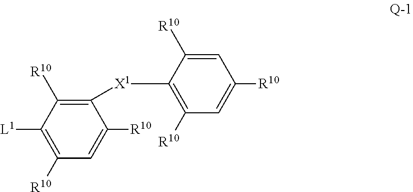

wherein X¹ is N—H or N⁻; each R¹⁰ is hydrogen or —NO₂, specifically —NO₂; and L¹ is a group linking to T, the membrane-spanning tether of Formula (1).

In an embodiment, every instance of R¹⁰ is —NO₂.

In another embodiment, L¹ is a bond, an amide group, an ether group, a carbamate group, a carbonate group, a substituted or unsubstituted C₁-C₁₀ carbohydryl chain, or a combination thereof “Carbohydryl” as used herein, includes both branched and straight-chain hydrocarbon groups, which are saturated or unsaturated, having the specified number of carbon atoms.

In another embodiment, the second chromophore (“Q”) is a non-fluorescent quencher that is a chromophore bromocresol green or derivative thereof.

In an embodiment, the second chromophore Q has the structure Q-2

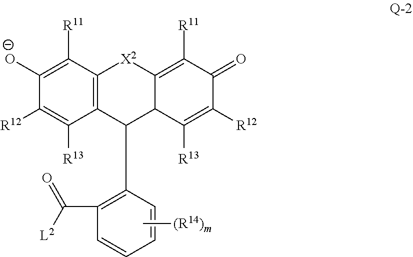

wherein X² is absent, O, S, or Si(CH₃)₂; R¹¹ is H, Br, Cl, or I; each R¹² and R¹³ independently is H, Br, Cl, NO₂, or I, or R¹² and R¹³ together form a divalent —CH═CH—CH═CH— group; R¹⁴ is H, C₁-C₁₀ alkyl, halogen, C₁-C₁₀ alkoxy, C₆-C₁₂ aryl, C₃-C₁₀ cycloalkyl, C₁-C₁₀ alkylthio, or C₁-C₁₀ haloalkyl; m is 0, 1, or 2; and L² is a group linking to T, the membrane-spanning tether of Formula (1). L² is a bond, an amide group, an ether group, a carbamate group, a sulfonate group, a carbonate group, a substituted or unsubstituted C₁-C₁₀ carbohydryl chain, or a combination thereof.

In an embodiment, the second chromophore Q has the structure Q-3

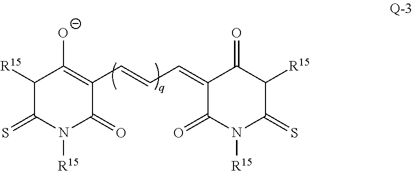

wherein q is 0, 1, or 2 and each R¹⁵ is independently C₁-C₁₂ alkyl, H, Br, Cl, I or NO₂ with the proviso that one R¹⁵ is L³ a group linking to T, the membrane-spanning tether of Formula (1). L³ is a bond, an amide group, an ether group, a carbamate group, a sulfonate group, a carbonate group, a substituted or unsubstituted C₁-C₁₀ carbohydryl chain, or a combination thereof.

The membrane-spanning tether T of Formula (1) is any flexible chemical structure that is capable of spanning the distance of a cell membrane.

In an embodiment, the membrane-spanning tether T comprises about 29 to about 35, specifically about 30 to about 34, more specifically about 31 to about 33, and yet more specifically about 32 linker atoms in length, wherein each linker atom may be a carbon, oxygen, or nitrogen.

In another embodiment, the membrane-spanning tether T comprises about 0 to about 6 ether groups, inclusive of 0, 1, 2, 3, 4, 5, and 6; specifically about 2 to about 4 ether groups; about 0 to about 6 amide groups, inclusive of 0, 1, 2, 3, 4, 5, and 6; specifically about 2 to about 4 amide groups; about 0 to about 6 polyethylene glycol groups, inclusive of 0, 1, 2, 3, 4, 5, and 6; specifically about 2 to about 4 polyethylene glycol groups; or a combination thereof.

In an embodiment, the membrane-spanning tether T is —(CH₂CH₂O)₂CH₂CH₂NH(C═O)—(CH₂)₁₁—NH(C═O)CH₂—(OCH₂CH₂)₂—NH(C═O)—CH₂CH₂—; —(CH₂)₁₂—NH(C═O)—(CH₂)₁₁—NH(C═O)CH₂—(OCH₂CH₂)₂—NH(C═O)—CH₂CH₂—; or —(CH₂)₁₂—NH(C═O)—(CH₂)₁₁—NH(C═O)—CH₂CH₂—.

Exemplary tethered bichromophoric fluorophore quenchers can be found in Table 1, herein.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, “—CHO” is attached through carbon of the carbonyl group.

Unless otherwise indicated, the term “substituted” as used herein means replacement of one or more hydrogens with one or more substituents. Suitable substituents include, for example, hydroxyl, C₆-C₁₂ aryl, C₃-C₂₀ cycloalkyl, C₁-C₂₀ alkyl, halogen, C₁-C₂₀ alkoxy, C₁-C₂₀ alkylthio, C₁-C₂₀ haloalkyl, C₆-C₁₂ haloaryl, pyridyl, cyano, thiocyanato, nitro, amino, C₁-C₁₂ alkylamino, C₁-C₁₂ aminoalkyl, acyl, sulfoxyl, sulfonyl, amido, or carbamoyl.

As used herein, “alkyl” includes straight chain, branched, and cyclic saturated aliphatic hydrocarbon groups, having the specified number of carbon atoms, generally from 1 to about 20 carbon atoms, greater than 3 for the cyclic. Alkyl groups described herein typically have from 1 to about 20, specifically 3 to about 18, and more specifically about 6 to about 12 carbons atoms. Examples of alkyl include, but are not limited to, methyl, ethyl, n-propyl, isopropyl, n-butyl, 3-methylbutyl, t-butyl, n-pentyl, and sec-pentyl. As used herein, “cycloalkyl” indicates a monocyclic or multicyclic saturated or unsaturated hydrocarbon ring group, having the specified number of carbon atoms, usually from 3 to about 10 ring carbon atoms. Monocyclic cycloalkyl groups typically have from 3 to about 8 carbon ring atoms or from 3 to about 7 carbon ring atoms. Multicyclic cycloalkyl groups may have 2 or 3 fused cycloalkyl rings or contain bridged or caged cycloalkyl groups. Examples of cycloalkyl groups include cyclopropyl, cyclobutyl, cyclopentyl, or cyclohexyl as well as bridged or caged saturated ring groups such as norbornane or adamantane.

In preliminary experiments, a FRET pair, dipicrylamine (DPA) anion and di-4-ANEPPTEA (ANEP=aminonaphthylethenylpyridinium; PTEA=propyltriethylammonium) cation was found that have the desirable FRET characteristics. In one embodiment they were linked with a hydrocarbon chain composed of 32 carbons. This initial proof of concept compound showed strong quenching of the ANEP (aminonaphthylethenylpyridinium) chromophore and the observed internal quenching was close to 100% efficient. However, this compound is too insoluble in water to be deliverable to membranes.

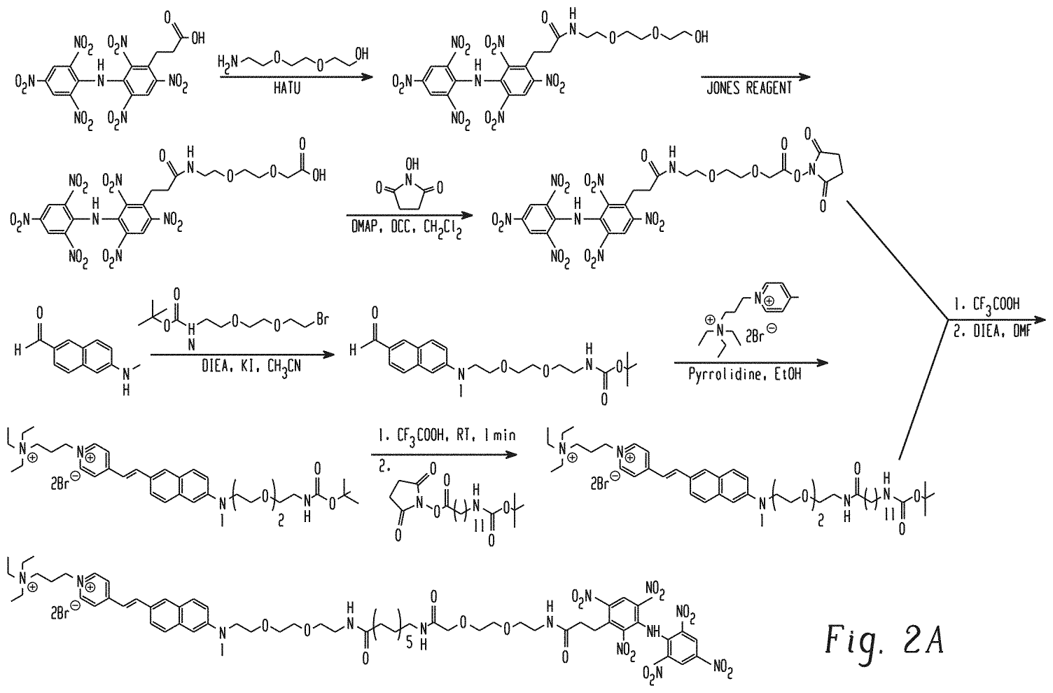

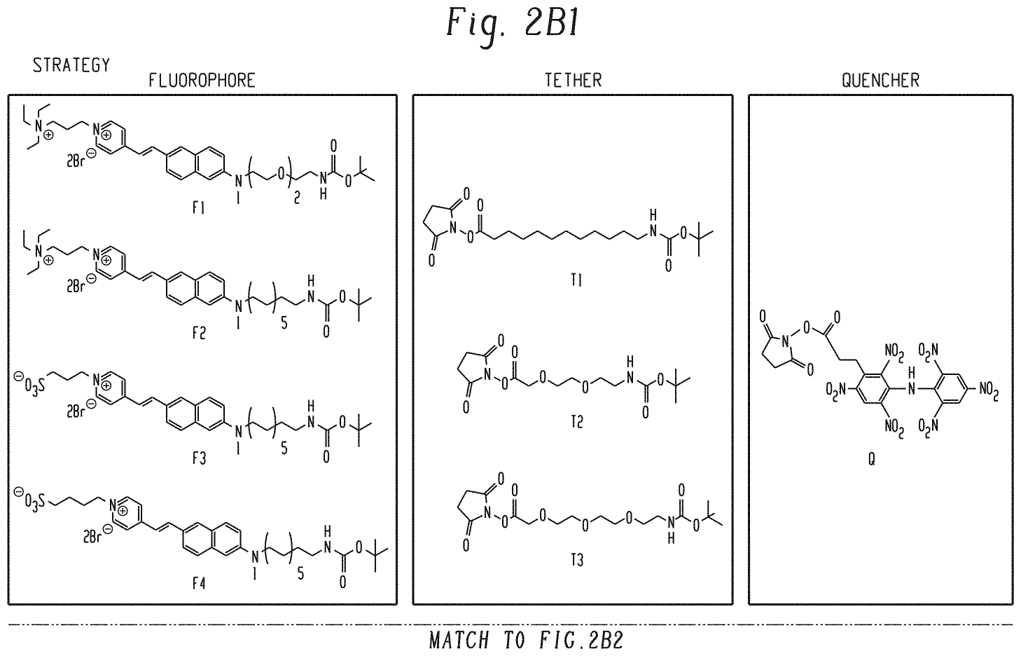

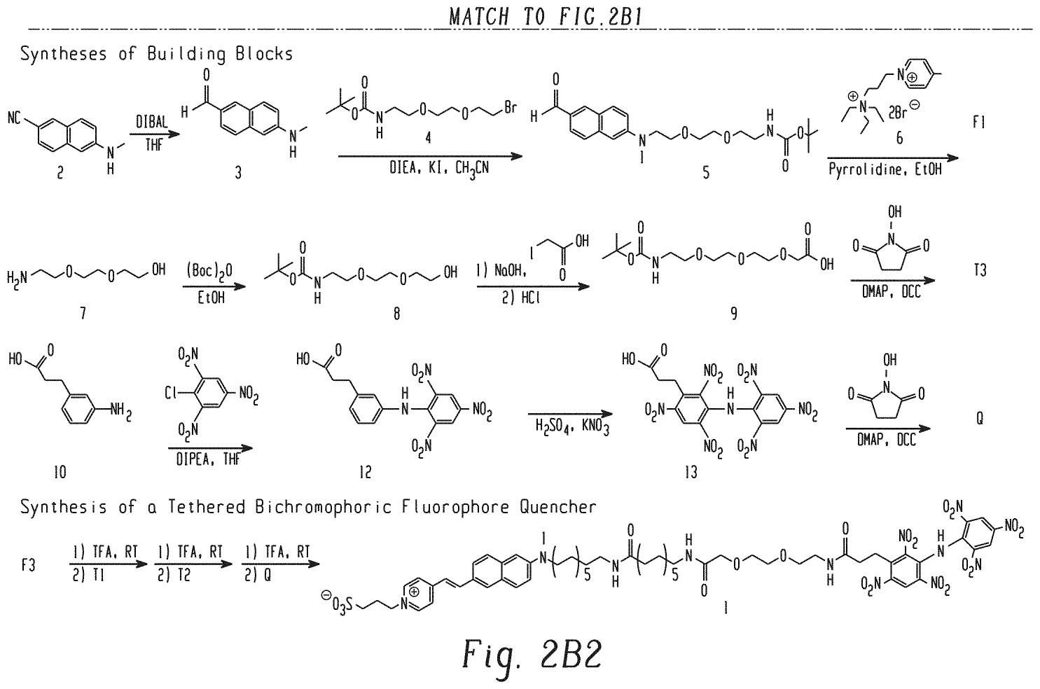

FIG. 2A discloses a synthetic scheme for making PY6084, which is a further proof of concept compound. The scheme is presented as an example of the general approach disclosed herein to link two chromophores with tethers of varying length and composition and with sidechains that impart varying charge and hydrophilicity to the ANEP chromophore. In some embodiments the tether comprises polyethylene glycol (PEG) moieties as well as hydrocarbon chains.

Likewise, FIG. 2B discloses a modular strategy that can be used to synthesize tethered flurophore-quencher dyes with tethers that are tunable both in length and hydrophilic/hydrophobic balance. The strategy relies on the convenient room temperature peptide formation chemistry between an amine group and an N-hydroxy succinimide ester. The building blocks consist of ANEP dyes with Boc-protected amine group (F1, F2, F3, F4), a DPA quencher with N-hydroxy succinimide ester group (Q), and various tethers with both Boc-protected amine and N-hydroxy succinimide ester groups at the opposite ends (T1, T2, T3). Hydrocarbon chain linkers T1 serves as hydrophobic building blocks while PEG chain linkers T2 and T3 serve as hydrophilic blocks. A linker block can repeat or be combined with other linker blocks in any order. Synthesis of F1, T3, and Q are also shown in FIG. 2B as examples. Other building blocks, F2-F4 and T1-T2, can be readily synthesized, as detailed in the Examples below. The last part of FIG. 2B shows synthesis of a typical TBFQ dye, TBFQ 1, which involves repetitive deprotection of an N-Boc group with TFA, and subsequent reaction with excess N-hydroxy succinimide ester at room temperature. The excess ester is used to drive the reaction to completion, but does not complicate later column chromatography purification since the product has a much higher polarity.

Importantly, the synthetic scheme in FIGS. 2A and 2B provides an example of how one can tune the hydrophobicity of the tether by incorporating polyethylene glycol groups to flank the hydrocarbon chain. By varying the proportion of PEG and hydrocarbon in the tether, one can tune the water solubility of the sensor and also optimize the speed by which the anionic dipycrylamine, or some other quencher molecule with appropriate spectral/quenching characteristics, flips across the membrane.

Compound PY6084 is one embodiment of a bichromophoric voltage-sensitive dye (BVSD) and is composed of a hemicyanine fluorophore at one end and dipicryl amine anion at the other. The latter is an effective general purpose quencher for almost any fluorophore as long as it is close enough to the fluorophore. When added to one side of a membrane the doubly positive charged hemicyanine moiety remains firmly anchored at the membrane surface, while the delocalized negative charge on the dipicrylamine allows it to readily permeate through to the opposite side. The tendency for the latter to be on one side or the other should be determined by the energetic competition between its interaction with the positively charged hemicyanine end and the voltage across the membrane.

The tether in PY6084 contains 32 linker atoms (carbons, oxygens and nitrogens) between the two chromophores—enough to span the 4 nm thickness of a lipid bilayer. The tether is also composed of a lipophilic hydrocarbon central section flanked by more hydrophilic ether and amide groups. The nature of the tether in this compound and in other compounds depicted below have been tuned to obtain sufficient water solubility while still allowing the tether to quickly traverse the membrane.

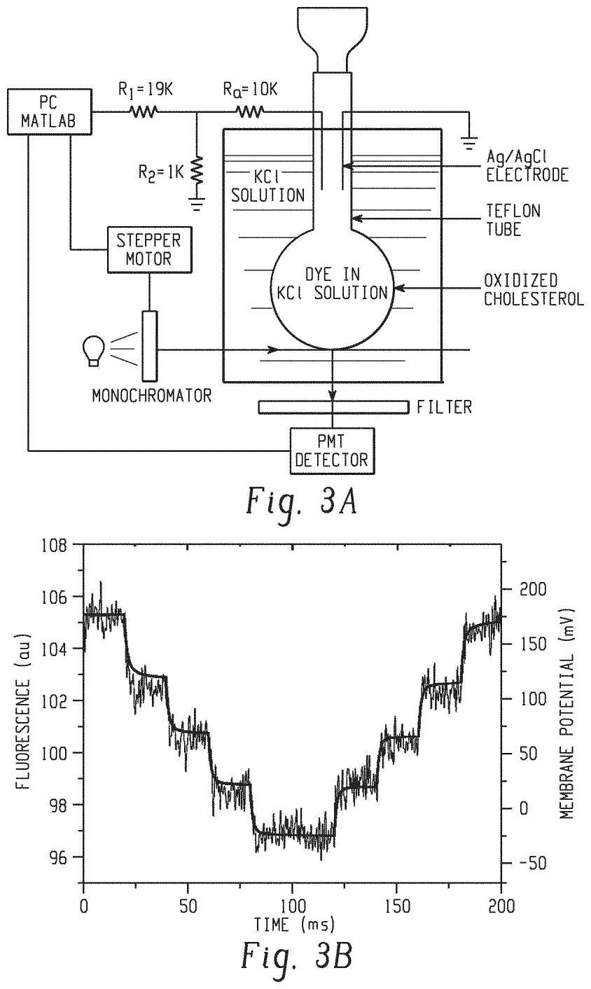

The bichromophoric VSDs can be characterized spectroscopically in ethanol, aqueous buffer and in lipid vesicle suspension to help assess baseline quenching and fluorescence quantum efficiency. They can also be studied with a hemispherical bilayer apparatus, FIG. 3, which allows one to precisely characterize the voltage-dependence and kinetics of VSD sensitivity.

FIG. 3 (A) is a setup of hemispherical lipid bilayer apparatus (not to scale). The resistance for the bubble is around 1MΩ. The dye solution was loaded to the internal side of the bubble (diameter ˜1 mm). A MATLAB program controls the output voltage, stepper motor for monochromator, and signal acquisition. FIG. 3 (B) shows averaged fluorescence from Di-4-ANEPPS (n=100) and membrane potential on the bubble. The membrane potential was calculated by integrating the current through Ra, and inverted for comparison purpose.

In an example, the voltage-clamped hemispherical lipid bilayer characterization of the sensitivity and kinetics of PY6084 was conducted. A square staircase of 20 ms voltage steps is applied across the membrane with the dye on the inside. The bottom of the bubble is excited and fluorescence emission collected through an appropriate filter at right angles with an avalanche photodiode. A monochromator is used for wavelength scanning and the electronics for signal averaging and processing, allowing for the determination of the kinetics of VSD response to voltage potential steps with sub-millisecond resolution. The results indicate that PY6084 is highly sensitive (36% change in fluorescence/100 mV), but only over a highly negative range of potential steps. Because the dye is applied on the inside, this means that highly negative potentials on the inside are required to drive the DPA moiety away from the hemicyanine fluorophore. Therefore, while the experiments demonstrate that the rationale for the tethered bichromophoric VSD works to produce high voltage sensitivity in PY6048, this particular VSD operates as a sensor outside the normal physiological voltage range.

Fifteen tethered bichromophoric VSDs molecules have been constructed and their sensitivity to membrane potential has been tested on the voltage clamped hemispherical bilayer apparatus (See Table 1, below.) The characterization of these additional tethered dyes provides more insight on how to optimize sensitivity, speed, solubility and to shift the voltage range to a more physiological regime. The best of these dyes, PY-6210, has a sensitivity of >150% per 100 mV in the correct physiological range. This is better sensitivity than any know fast VSD (where fast is defined as <100 ms). It has a somewhat slower response time on the hemispherical bilayer of 15 ms, but some of the other dyes depicted point to structural features that will allow one to reach the action potential time scale.

TABLE 1
Tethered Dye Comparison. “Tₛₜₑₚ” is the duration in milliseconds of
the voltage pulse used in a given experiment. It should be noted that the speed of response for
each dye must be faster than the indicated Tₛₜₑₚ or else no change in fluorescence would be
seen. The percentages shown in the Comment column are calculated based on the change in
fluorescence divided by the maximum fluorescence.

| Name; | |
|---|---|
| ΔF/F per | |
| 100 mV in | |
| Dynamic | |
| Range | |
| (mV), τ- | |
| on (msec), | |
| τ-off | |
| (msec) | Structure |
| TBFQ 14 (PY6017); No fluorescence signal | 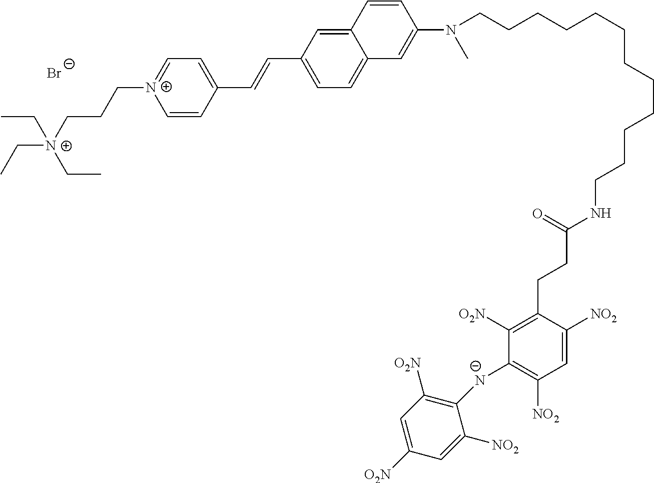 [SMILES: CC[N+](CC)(CC)CCC[n+]1ccc(/C=C/c2ccc3cc(N(C)CCCCCCCCCCCCNC(=O)CCc4c([N+](=O)[O-])cc([N+](=O)[O-])c([N-]c5c([N+](=O)[O-])cc([N+](=O)[O-])cc5[N+](=O)[O-])c4[N+](=O)[O-])ccc3c2)cc1 ; [Br-]] |
| TBFQ 15 (PY6021); Electrochromic behavior; 8 ± 3% (n = 5) | 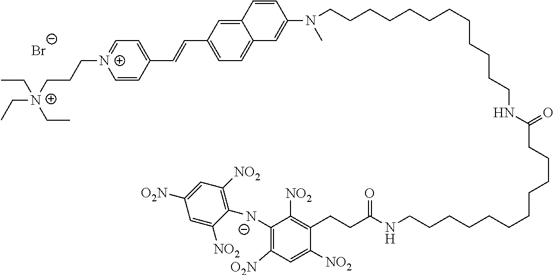 [SMILES: CC[N+](CC)(CC)CCC[n+]1ccc(/C=C/c2ccc3cc(N(C)CCCCCCCCCCCCNC(=O)CCCCCCCCCCCNC(=O)CCc4c([N+](=O)[O-])cc([N+](=O)[O-])c([N-]c5c([N+](=O)[O-])cc([N+](=O)[O-])cc5[N+](=O)[O-])c4[N+](=O)[O-])ccc3c2)cc1 ; [Br-]] |
| TBFQ 16 (PY6084); 56 ± 13% (n = 5) in [−200, −100], 11 ± 2, 5 ± 1 | 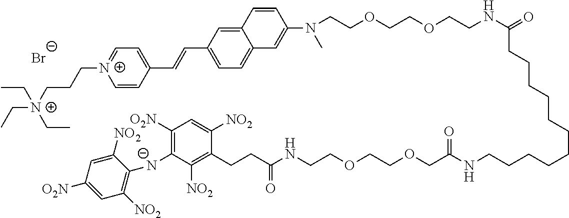 [SMILES: CC[N+](CC)(CC)CCC[n+]1ccc(/C=C/c2ccc3cc(N(C)CCOCCOCCNC(=O)CCCCCCCCCCCNC(=O)COCCOCCNC(=O)CCc4c([N+](=O)[O-])cc([N+](=O)[O-])c([N-]c5c([N+](=O)[O-])cc([N+](=O)[O-])cc5[N+](=O)[O-])c4[N+](=O)[O-])ccc3c2)cc1 ; [Br-]] |
| TBFQ 17 (PY6086); 66 ± 15% (n = 4) in [−100, 0], 12 ± 2, 7 ± 2 | 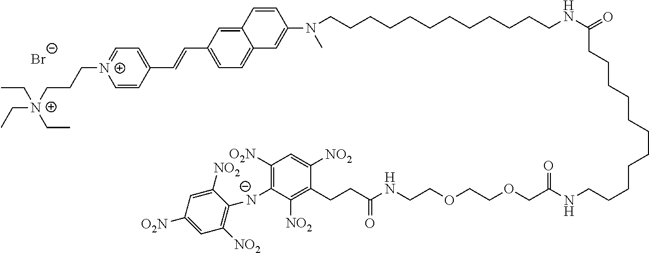 [SMILES: CC[N+](CC)(CC)CCC[n+]1ccc(/C=C/c2ccc3cc(N(C)CCCCCCCCCCCCNC(=O)CCCCCCCCCCCNC(=O)COCCOCCNC(=O)CCc4c([N+](=O)[O-])cc([N+](=O)[O-])c([N-]c5c([N+](=O)[O-])cc([N+](=O)[O-])cc5[N+](=O)[O-])c4[N+](=O)[O-])ccc3c2)cc1 ; [Br-]] |
| TBFQ 18 (PY6128); 64 ± 22% (n = 5) in [−200, −100], 10 ± 2, 8 ± 2 | 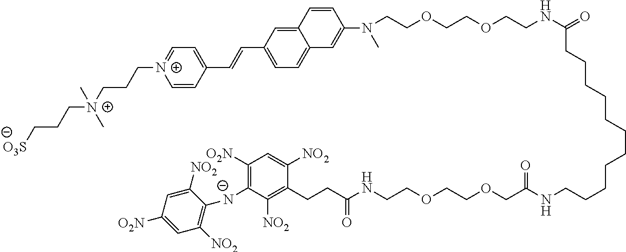 |
| TBFQ 1 (PY6210); 150 ± 33% (n = 9) in [−100, 0], 17 ± 2, 13 ± 2 | 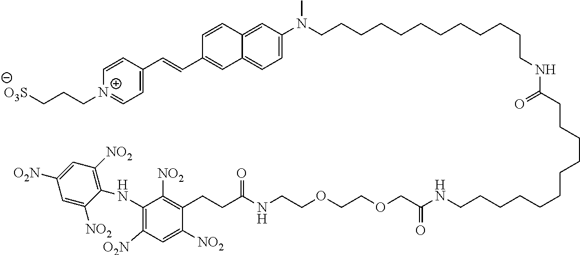 |
| TBFQ 19 (PY6221); Low Membrane Fluorescence | 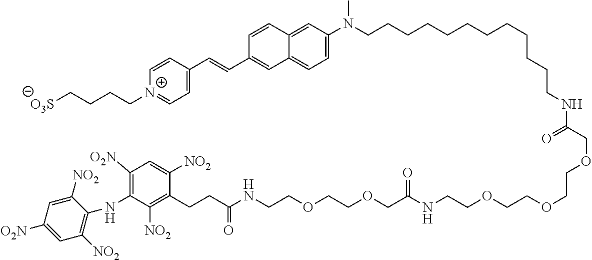 |
| TBFQ 20 (PY6225); 92 ± 20% (n = 3) in [−100, 0], 25 ± 2, 20 ± 2 | 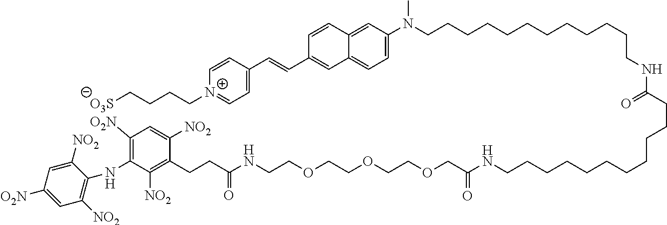 |
| TBFQ 21 (PY6227); Low Membrane Fluorescence | 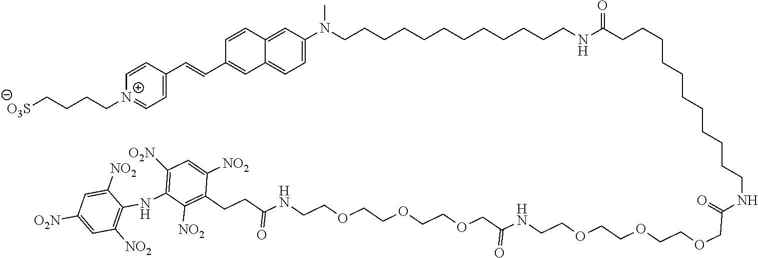 |
| TBFQ 22 (PY6229); 20 ± 7% (n = 3) in [−200, −100], 50 ± 15, 20 ± 5 | 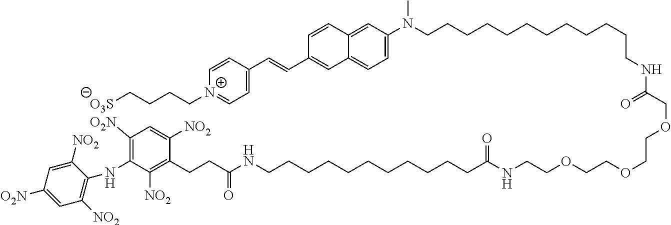 |
| PY6242; Low solubility Not binding Low fluorescence | 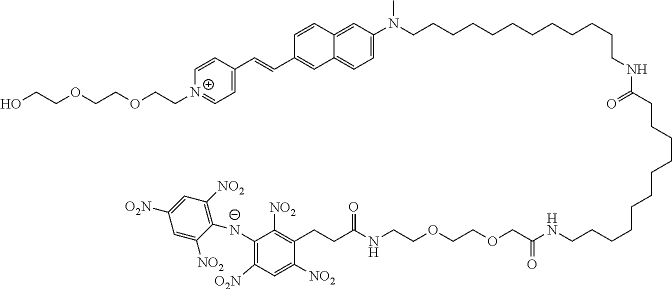 [SMILES: CN(CCCCCCCCCCCCNC(=O)CCCCCCCCCCCNC(=O)COCCOCCNC(=O)CCc1c([N+](=O)[O-])cc([N+](=O)[O-])c([N-]c2c([N+](=O)[O-])cc([N+](=O)[O-])cc2[N+](=O)[O-])c1[N+](=O)[O-])c1ccc2cc(/C=C/c3cc[n+](CCOCCOCCO)cc3)ccc2c1] |
| TBFQ 23 (PY6254); Low Membrane Fluorescence | 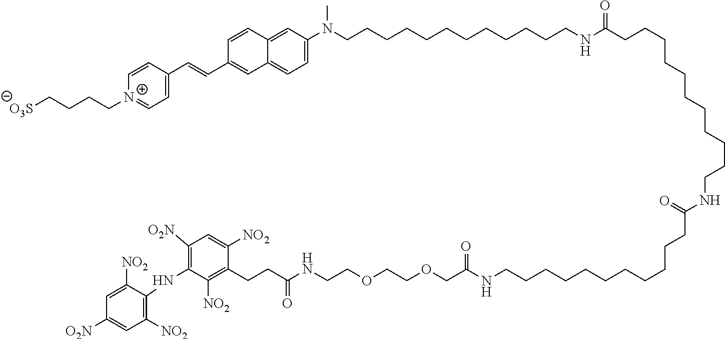 |
| TBFQ 24 (PY6255); 40 ± 10% (n = 3) in [−100, 0], 16 ± 2, 10 ± 1 | 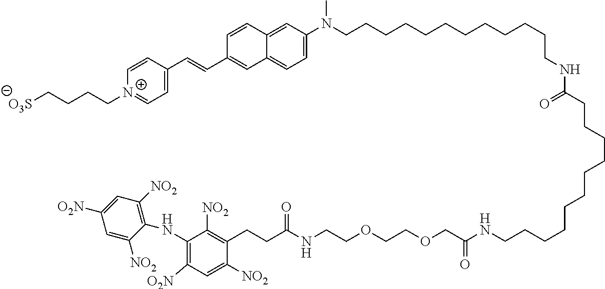 |
| PY6256; 39% in [0, 100] 24% in [−100, 0] FAST, and Linear Low Fluorescence | 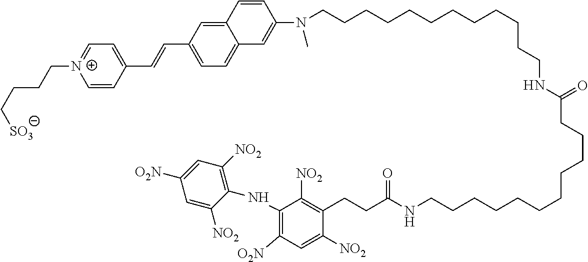 |
| TBFQ 25 (PY6257); Low Membrane Fluorescence | 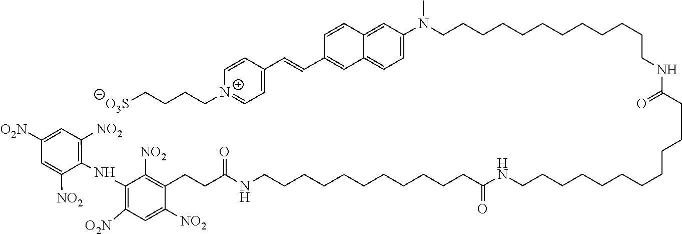 |

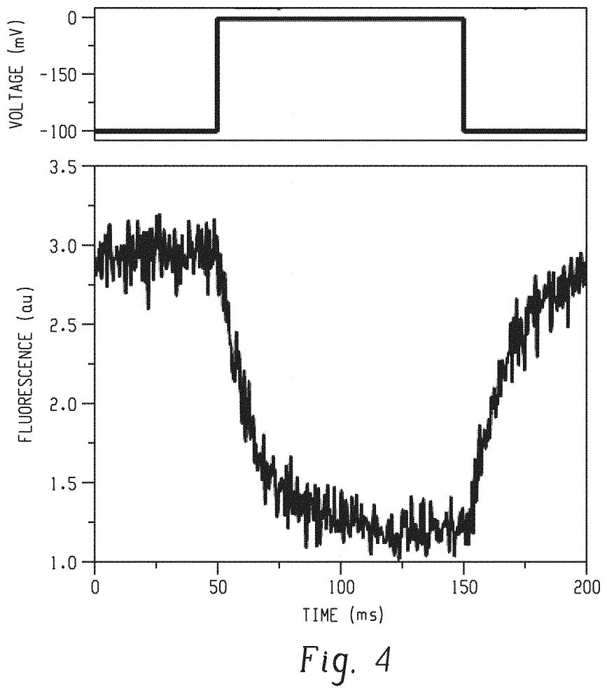

The voltage sensitivity of TBFQ 1(PY6210) is shown in the kinetic trace of FIG. 4 derived from the hemispherical bilayer experiment. In Table 1, the sensitivities are calculated based on the change in fluorescence divided by the maximum fluorescence. So for PY6210, a 60% change per 100 mV really represents close to a 3-fold decrease; in other words, if one calculates the % change by dividing instead by the minimum fluorescence, one would get close to 150% sensitivity. Indeed, the minimum fluorescence for PY6210 occurs at 0 mV, which would normally be defined as the baseline and F(−100 mV)−F(0 mV)]/F(0 mV) is therefore ˜150%/100 mV. This is better appreciated in the figure of the kinetic response, which shows the fluorescence intensity directly in response to a 100 millisecond, 100 mV voltage pulse. FIG. 4 also shows that the response is fast with a time constant of <20 ms. This is by far the most sensitive fast voltage sensitive dye ever made. The best ones in common use show only a 20% fluorescence change per 100 mV.

Of the compounds in Table 1, TBFQ 14 (PY6017) is nonfluorescent due to the very short tether; even when stretched, this tether would be shorter than the R₀ of 2.6 nm and is too short to span the thickness of a lipid bilayer. Not wishing to be bound by theory, the ANEP and DPA chromophores are presumed to remain close to each other on one side of the membrane at any applied voltage. TBFQ 15 (PY6021) shows a wavelength-dependent voltage sensitivity that is typical of electrochromic mechanism from the parent ANEP dyes (e.g. Di-4-ANEPPS); i.e. the voltage-dependent fluorescence change displays a biphasic wavelength dependence; a quenching mechanism is expected to be independent of excitation wavelength (e.g. the two-component DPA/Di-4-ANEPPS). The sensitivity of electrochromic dyes is typically <20%/100 mV and TBFQ 15 (PY6021) is 8%.

TBFQ 16 (PY6084) has a longer tether at 32 atoms, sufficient to span the membrane. It also has polyethyleneglycol (PEG) moieties flanking a central hydrocarbon building block. It produces high voltage sensitivity via the quenching mechanism, but the optimal sensitivity range is between −200 and −100 mV, which is outside of normal physiological range for an action potential of approximately −70 to +30 mV. Not wishing to be bound by theory, but a possible reason for this behavior may be that a strong hyperpolarizing potential is required to break the electrostatic interaction between positively charged side chains on the ANEP chromophore (which is also positively charged) and the negatively charged DPA. That is, it takes a large negative electric field to induce the DPA to move to the opposite side of the membrane. Another possible contribution to the stability of the folded conformation with donor and acceptor on the same side of the membrane is that the hydrophilic PEG groups are more stably solvated when they are adjacent to each other at the aqueous-lipid interface. These two possibilities may be distinguished by considering compounds TBFQ 17 (PY6086) and TBFQ 18 (PY6128). Both of these display better sensitivity than TBFQ 16. However, TBFQ 17, which is similar in structure to TBFQ 16, but without the PEG moiety near the ANEP chromophore, is superior because it has its optimal sensitivity in the physiological range. In contrast the appended negative sidechain in TBFQ 18 does not appreciably shift the operating range of the voltage sensitivity displayed in TBFQ 16.

A tether containing too many PEG groups (as in compounds TBFQ 19 (PY6221) and TBFQ 21 (PY6227)) rendered the VSDs too water soluble to become associated with the membrane, resulting in poor membrane staining. On the other hand, eliminating the PEG as in TBFQ 25 (PY6257), or too large a hydrocarbon region as in TBFQ 23 (PY6254), made the VSDs too water insoluble to be delivered to the membrane. VSDs TBFQ 17, TBFQ 20, TBFQ 24, and TBFQ 1 all have a good balance of tether and side chain properties to produce responses in the physiological range that are larger than any previous fast VSDs.

TBFQ VSD, 1, included a single glycol ether adjacent to the DPA and a negatively charged propylsulfonate group on ANEP chromophore. It displayed a remarkable 150% ΔF/F per 100 mV; that is, the fluorescence changes by 2.5 fold between −100 mV and 0 mV. Sensitivity of this magnitude is unprecedented in voltage sensitive dyes.

The kinetics of the fluorescence response for TBFQ1 reveals that by fitting the curve to single exponential decay the time constant i was found to be 13 ms for the depolarization phase, and 17 ms for the repolarization phase. In literature time constants reported varies from 0.12 to 0.54 ms when DPA was used as the quencher in two-component FRET systems. Not wishing to be bound by theory, apparently the tether slows down the movement of quencher. However it is still on par with most protein based voltage indicators such as ArcLight. TBFQ1 should be fast enough to detect spikes in brain or to faithfully follow cardiac action potentials in some species (including human).

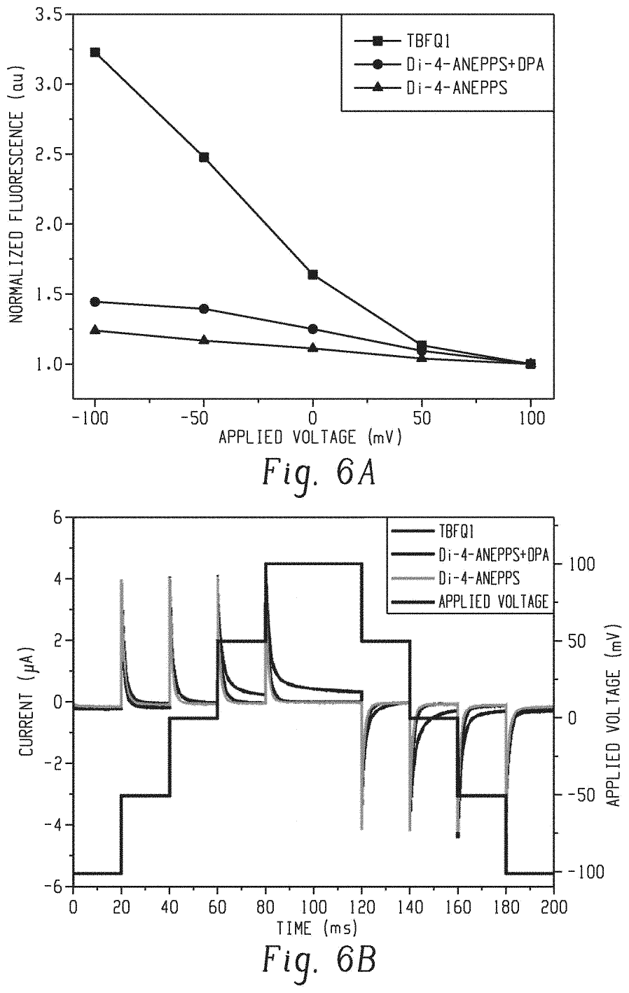

In FIG. 6, TBFQ1 was directly compared to Di-4-ANEPPS and the two-component system of Di-4-ANEPPS/DPA using the hemispherical bilayer. FIG. 6A demonstrates the dramatic improvement in the voltage sensitivity of TBFQ1. FIG. 6B is an electrical measurement of current through the hemispherical bilayer membrane induced by the voltage pulses. The transient currents are dues to capacitive charging of the membrane. However there is also a significant DC current for the two-component system which could produce significant pharmacological effects in vivo. It was determined that the sensitivity of TBFQ1 does not have any significant dependence on VSD concentration, while the two-component system is highly sensitive to concentration. It was further found that the responses of both TBFQ1 and the two-component system are stable over multiple trials with no photobleaching.

The fluorescence quantum yield (FQY) for TBFQ1 was measured to be 1.6% when bound to lipid vesicle membranes. This is approximately a factor of 15 lower than the parent ANEPPS dyes. Not wishing to be bound by theory, but it is believed this is due to significant quenching by the DPA moiety even when TBFQ1 is in a stretched conformation. The structure of the TBFQ dye can be modified to achieve optimal quenching efficiency. Too little quenching will not yield much voltage sensitivity; while too much quenching results in a very low baseline fluorescence signal, impeding practical applications to neuroscience and cardiology.

In preferred embodiments the linker (membrane-spanning tether) is about 28 to 30 to 32 to 34 to 36 linker atoms in length, and the linker atoms may be carbon, oxygen or nitrogen. Preferred linkers may comprise about 0 to about 2 to about 4 to about 6 ether groups, about 0 to about 2 to about 4 to about 6 amide groups or about 0 to about 2 to about 4 to about 6 polyethylene glycol groups, or any combinations of the above.

To solve the problem of shifting and broadening the operable voltage range, one can modify the structure by altering the sidechains on the hemicyanine fluorophore. By replacing the triethyl ammonium group by a sulfonate, as in PY-6120 for example, one can reduce the electrostatic attraction between the negative DPA and the hemicyanine, thus shifting the voltage range toward the physiologically relevant. Additional fluorophore and quencher pairs are being synthesized and tested to optimize voltage sensitivity in the physiological range and also to take the wavelength range further out to the red and near infrared. As a matter of routine, one first characterizes the behavior of two-component versions of these pairs with the hemispherical bilayer systems before synthesizing the tethered versions.

It is an object of the disclosed compounds and methods to optimize the length and composition of the tether to assure solubility, to obtain response kinetics on action potential time scales and to achieve deep staining in brain slice experiments ultimately in in vivo preparations. It is anticipated that dye systems based on the methods and compounds disclosed herein are capable of response times on the order of 2 to 4 milliseconds.

It is a further object of the disclosed methods and compounds to produce highly sensitive fast voltage sensors for both fluorescence and photoacoustic (PA) voltage imaging.

Most important, experiments on all disclosed dyes and tethered dye pairs have provided great insight into how to improve the properties even further to improve the brightness through the use of other fluorophore—quencher pairs such that FRET is decreased; to extend to other wavelength ranges, for example by use of dye pairs such as that shown in FIG. 5; and to improve effectiveness of delivery to cells and tissues by tuning the solubility of the tethered bichromophoric VSD by the selection of the proportion of PEG, ether, amide and hydrocarbon groups in the tether. Delivery of the disclosed VSDs can also be enhanced by changing the head group of the fluorophore or by encapsulating the VSDs, such as through the use of nanoparticles.

It is an advantage of the disclosed compounds and methods to provide a 150% change in fluorescence in response to a 100 mV change in membrane potential. The scope of the disclosed compounds and methods further comprises brighter versions of the compounds, by selecting different fluorophores, and the extension of chromophore spectral characteristics to the near infrared.

Disclosed herein are synthetic methods and compound structures for the building of TBFQ (tethered bichromophoric fluorophore quencher) systems. The available data on how their structural features control sensitivity and kinetics enable design and synthesis of VSDs further to the red and near infrared VSDs for both photoacoustic (PA) and fluorescence imaging. An example is the compound at the end of the synthetic scheme depicted in FIG. 5. It has a non-fluorescent quencher embodied by the chromophore bromocresol green and a fluorophore consisting of a Cy5.5 chromophore (abs max 680 nm). Bromocresol green has a pKa of 4.8 and is shown in its neutral protonated form. At physiological pH it will be doubly anionic, imparting stronger sensitivity to membrane potential than DPA (dipicrylamine). However, the small fraction of the neutral protonated form will catalyze rapid equilibration across the membrane, giving this Quencher an added advantage over DPA. Importantly, all VSDs will lend themselves well to a dual wavelength scheme, whereby excitation within the Quencher absorbance band will produce a steady voltage-insensitive PA signal, while excitation into the fluorophore band will produce voltage-sensitive PA; the ratio of these two PA signals will thus normalize away any spatial or temporal variation in VSD concentration as well as local changes in volume due to, for example in in vivo experiments, changes in blood flow.

The tethered bichromophoric fluorophore quencher systems discussed herein exhibit unprecedentedly high voltage sensitivities and sufficiently rapid response to detect action potentials. For those systems where the fluorescence quantum yield is relatively low (e.g. 1.6%) compared with most organic voltage sensors, they will still find use in in vitro applications, such as cell-based drug screening assays because fluorescence detection is not light intensity limited in such applications. Other systems with higher fluorescence quantum yield can find use for fast high resolution in-vivo imaging of electrical activity.

### Examples

Hemispherical Lipid Bilayer (HLB) Apparatus for Voltage Sensitivity Testing

A hemispherical bilayer apparatus was used to apply well controlled voltage steps while recording the fluorescence from a thinly illuminated arc at the bottom of the membrane. The apparatus consists of a lipid bilayer membrane that is expanded by hydrostatic pressure at the tip of a Teflon pipet containing 100 mM KCl. The resulting bubble is suspended in a cuvet for fluorescence recording; electrodes in the cuvet and inside the pipet serve to apply voltage steps. FIG. 3 shows the setup of a HLB system for characterizing the voltage sensitivity of VSDs. A MATLAB program can apply voltage as a programmable series of stair case steps (Figure S3B) via a National Instruments PCI-MIO-16E-4 DAQ card. In this way fluorescence for a series of membrane potentials can be conveniently obtained in one scan. To allow for finer control, the voltage output of the D to A converter card in the PC is divided by a factor of 20 via R₁ and R₂. The lipid bilayer has a capacitance of approximately 1 ρF, giving rise to a transient current that can be measured across Ra (see FIG. 6). The shape of the membrane potential steps was then calculated as the integration of charging current through Rₐ. Fluorescence detection was accomplished with a Hamamatsu GaAsP PMT module (H10770PA-40, non-cooled) with output connected first to a Femto DLPCA-200 and finally an EG&G Parc 113 (30 kHz low-pass) preamplifier before sampling by the DAQ card at 200 kHz. Fluorescence data was further filtered in MATLAB using a Type I Chebyshev low-pass filter with a 1 kHz cutoff frequency (3 dB), implemented by MATLAB's filtfilt function for zero phase filtering. The time constant for charging the bubble in FIG. 3B was found to be 1.7 ms, but it depends on sizes of bubble from experiment to experiment.

Using this apparatus, a comparison of the responses of Di-4-ANEPPS (4-(2-(6-(dibutylamino)-2-naphthalenyl)ethenyl)-1-(3-sulfopropyl)pyridinium hydroxide inner salt) to the Di-4-ANEPPS/DPA pair show that wavelength dependence of the Di-4-ANEPPS is biphasic, as is characteristic of electrochromic VSDs; these results actually represent combined effects from the voltage-dependence arising from the shifted excitation and emission spectrum, which is being detected at the red edge. The relative fluorescence response to the voltage-dependent translocation of the DPA quencher would not be expected to be wavelength dependent; however the results display wavelength dependence because of the superposition of the electrochromic mechanism with the quencher translocation mechanism. Di-4-ANEPPS gives an approximately linear voltage dependence over a broad range of applied voltage, but with a modest sensitivity of 12%/100 mV, as reported previously. The donor/acceptor pair produce a much larger peak response of 16%/100 mV in the range of −50 mV to +50 mV. The latter is non-linear, as would be expected from a voltage-dependent redistribution of DPA across the membrane; it also depends on the initial placement of the donor and acceptor pairs on opposite sides of the membrane; if they are added to the same side, no voltage sensitivity is observed. The differences in the behavior displayed in the voltage sensitivity data for Di-4-ANEPPS and Di-4-ANEPPS/DPA allow one to distinguish between a pure electrochromic VSD response and the quencher translocation mechanism.

In the two-component system, a high concentration of acceptor is required to assure that quenching will occur in the depolarized state. In practice, however, the DPA is used at concentrations below 4 μM to minimize pharmacological effects. By tethering the donor and acceptor moieties, they will be close enough for quenching in the depolarized state and also minimize the required VSD concentration. For a quencher to move all the way across a cell membrane, a minimum 4 nm tether is needed, which is about the length of an alkyl chain with 32 carbon atoms. Since 4 nm is significantly larger than the R₀ of 2.6 nm for these hemicyanine/DPA donor/acceptor pairs, a big change of FRET efficiency, and thus the fluorescence, can be expected even though it is tethered. A series of TBFQ molecules with varying side chains and tethers were synthesized all using the aminonaphthylethenypyridinium(ANEP)-DPA donor-acceptor pair. The fluorescence responses of TBFQ VSDs to voltage steps applied to the hemispherical lipid bilayer were then determined to arrive at design principles for optimizing TBFQ voltage sensitivity.

Synthesis of TBFQ Starting Materials

General.

All chemicals were purchased from commercial sources (Sigma Aldrich, Acros, TCI America, Combi-Blocks, and others) and used without further purification. Column chromatography was generally performed on silica gel (60 Å, 63-200 μm) from Sigma-Aldrich except for the some final products, which were purified on Unibond Amino silica gel from Analtech. Thin layer chromatography (TLC) was carried out on EM 60 F-254 plastic TLC plates. NMR spectra were recorded on Varian 400 MHz, 500 MHz, and 800 MHz instruments at the UConn Heath Structural Biology Facility. All spectra are referenced internally to TMS or residual solvent signals. Electrospray ionization (ESI) high resolution mass spectra (HRMS) were obtained on a QStar Elite (AB Sciex) at the Department of Chemistry, University of Connecticut. UV/Vis absorption spectra were recorded on a UV-Visible spectrophotometer (Shimadzu, UV-1601PC) and fluorescence emission spectra on a Horiba Fluorolog spectrofluorometer (Horiba, Inc., Edison, N.J.). Fluorescence quantum yield for dyes was determined by a relative method using Rhodamine 6G as the reference (excited at 480 nm, FQY=0.95 in EtOH).

### 6-Methylamino-naphthalene-2-carbaldehyde (3)

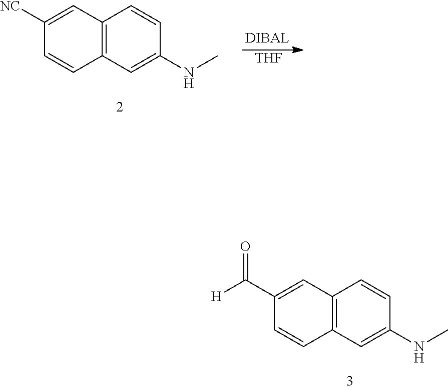

6-Methylamino-naphthalene-2-carbonitrile (2) was synthesized according to a literature procedure.⁴ 12 mL of 1.0 M DIBAL in THF was added slowly to a solution of 0.6 g of 6-methylamino-naphthalene-2-carbonitrile (2) in 10 mL anhydrous THF at −78° C. After 30 min the mixture was allowed to warm up to room temperature, and react for 1 h more. 10 mL saturated ammonium chloride aqueous solution was added slowly, and then 50 mL 1N HCl solution and 50 mL ethyl acetate was added subsequently. The mixture was stirred for 30 min. The organic layer was separated, and the aqueous layer was extracted with more ethyl acetate (3×30 mL). The ethyl acetate extracts were combined, concentrated under vacuum. Column chromatography (SiO₂, CH₂Cl₂) gave 3 as a yellow solid (308 mg, 51%). R_{f}(silica gel, 1:1 EtOAc/Hexane)=0.54; ¹H NMR (400 MHz, CDCl₃): δ 10.02 (s, 1H), 8.14 (s, 1H), 7.84 (dd, J=2, 9 Hz, 1H), 7.75 (d, J=9 Hz, 1H), 7.66 (d, J=9 Hz, 1H), 6.93 (dd, J=2, 9 Hz, 1H), 6.79 (d, J=2 Hz, 1H), 4.23 (s, 1H), 2.98 (s, 3H).

### Tert-butyl [2-(2-{2-[(6-formyl-naphthalen-2-yl)-methyl-amino]-ethoxy}-ethoxy)-ethyl]-carbamate (5)

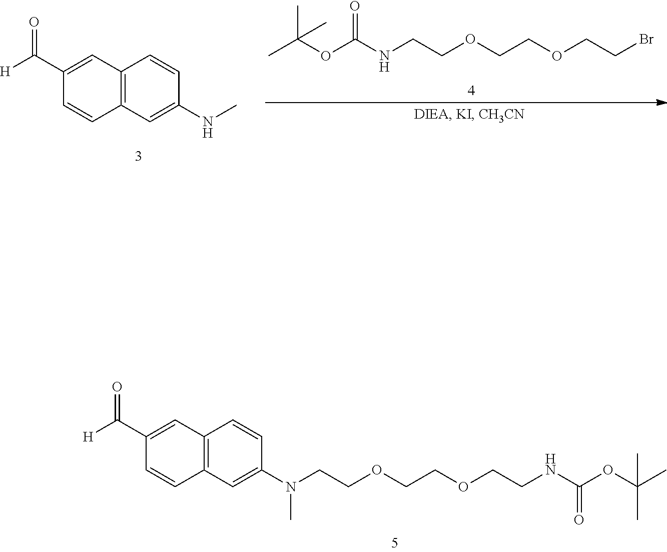 [SMILES: CNc1ccc2cc(C=O)ccc2c1 ; CC(C)(C)OC(=O)NCCOCCOCCBr ; CN(CCOCCOCCNC(=O)OC(C)(C)C)c1ccc2cc(C=O)ccc2c1]

Tert-butyl {2-[2-(2-bromo-ethoxy)-ethoxy]-ethyl}-carbamate (4) was synthesized according to literature methods. To a pressure vessel were added 3 (50 mg, 0.27 mmol), 4 (168.6 mg, 0.54 mmol), KI (90 mg, 0.54 mmol), N,N-diisopropylethylamine (105 mg, 0.81 mmol), and acetonitrile (1 mL). The pressure vessel was sealed and allowed to react at 130° C. for 2 days. Upon cooling down the mixture was purified by column chromatography (SiO₂, solvent gradient: CH₂Cl₂ to 1:1 EtOAc/CH₂Cl₂) to give 5 as a yellow oil (48 mg, 43%). R_{f}(silica gel, 1:1 EtOAc/Hexane)=0.22; ¹H NMR (500 MHz, CDCl₃): δ 10.00 (s, 1H), 8.17 (s, 1H), 7.81 (d, J=9 Hz, 2H), 7.64 (d, J=9 Hz, 1H), 7.19 (d, J=9 Hz, 1H), 6.89 (s, 1H), 4.94 (s, 1H), 3.71 (s, 4H), 3.55-3.63 (m, 4H), 3.51 (t, J=5 Hz, 2H), 3.30 (br q, J=5 Hz, 2H), 3.15 (s, 3H).

### Synthesis of F1

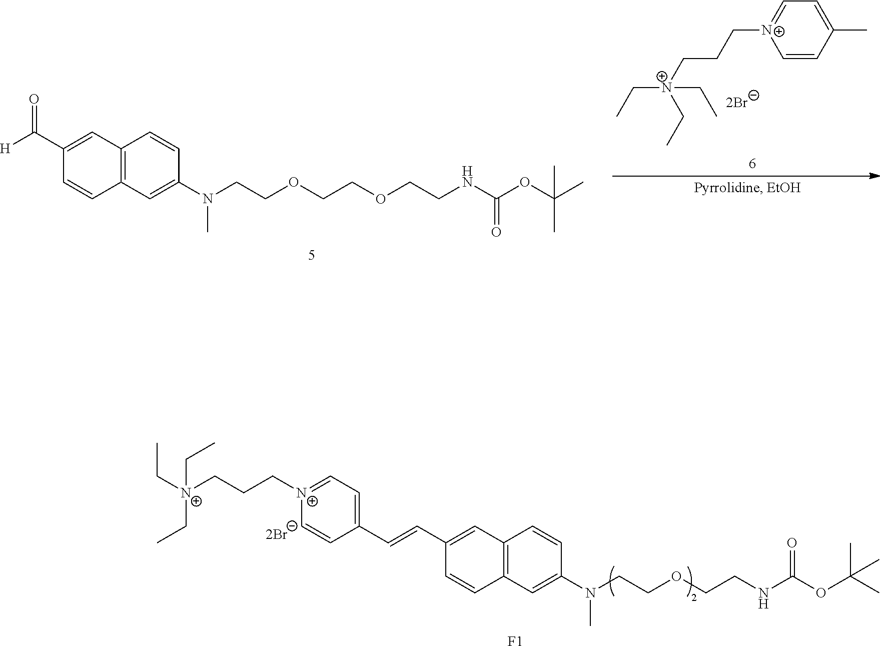

4-Methyl pyridinium salt 6 was synthesized according to a published method.6 A mixture of 5 (10 mg, 24 μmol), 6 (9.5 mg, 24 μmol), and pyrrolidine catalyst (20 μL) was stirred in 1 mL EtOH at room temperature for 16 hrs. The solution turned red. The solvents were evaporated under vacuum. The residue was purified by column chromatography (SiO₂-amino, solvent gradient: CH₂Cl₂ to 1:9 MeOH/CH₂Cl₂) to give F1 as a red solid (8 mg, 44%). R_{f}(silica gel, 24:4:16:6:6 CH₂Cl₂/i-PrOH/MeOH/H₂O/HOAc)=0.32; ¹H NMR (500 MHz, CD₃OD): δ 8.75 (d, J=6 Hz, 2H), 8.17 (d, J=6 Hz, 2H), 8.06 (d, J=16 Hz, 1H), 7.97 (s, 1H), 7.76 (d, J=9 Hz, 2H), 7.67 (d, J=9 Hz, 1H), 7.38 (d, J=16 Hz, 1H), 7.26 (dd, J=2.9 Hz, 1H), 6.96 (d, J=2 Hz, 1H), 4.58 (t, J=7.5 Hz, 2H), 3.73 (m, 4H), 3.58-3.62 (m, 4H), 3.46 (t, J=6 Hz, 2H), 3.38 (q, J=7 Hz, 8H), 3.16 (t, J=5.5 Hz, 2H), 3.15 (s, 3H), 2.45 (m, 2H), 1.42 (s, 9H), 1.33 (t, J=7 Hz, 9H).

### Synthesis of 12-(Boc-amino)-1-dodecylbromide (26)

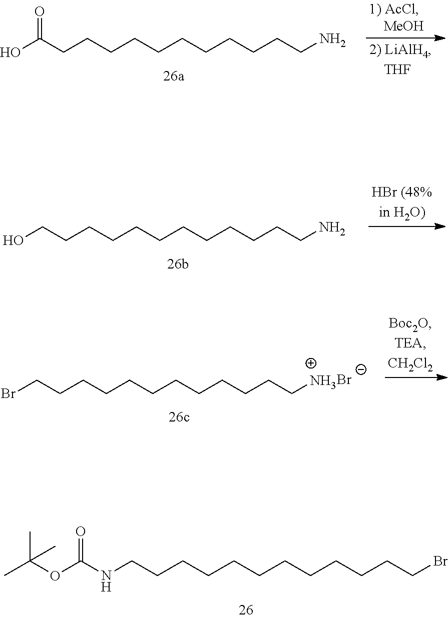 [SMILES: NCCCCCCCCCCCC(=O)O ; NCCCCCCCCCCCCO ; [Br-] ; [NH3+]CCCCCCCCCCCCBr ; CC(C)(C)OC(=O)NCCCCCCCCCCCCBr]

### 12-Amino-1-dodecanol (26b)

To a stirred suspension of 12-aminododecanoic acid (4.3 g, 20 mmol) in 20 mL MeOH at 0° C. was added acetyl chloride (3.6 mL, 2.5 equiv) dropwise. The mixture was then refluxed for 3 h. The solvent was then distilled off under reduced pressure. The white solid obtained was used for the next step without further purification. 100 mL anhydrous THF was added, and then Lithium aluminum hydride (3.2 g, 84 mmol) was added portionwise at 0° C. The mixture was heated under reflux for 16 h. The mixture was cooled down to 0° C., and quenched by 10 mL ice water. 6 mL 15% NaOH(aq) solution was added, and the mixture was stirred at room temperature for 1 h. The gray LiAlH₄ turned into off white precipitates and was filtered off, washed with CH₂Cl₂ and MeOH. The filtrate was concentrated to give 12-amino-1-dodecanol (26b) as a white solid (3.18 g, 79%). This material was used for the next step reaction without further purification. ¹H NMR (400 MHz, CDCl₃): δ 3.64 (t, J=6.6 Hz, 2H), 2.68 (t, J=7.0 Hz, 2H), 1.56 (m, 2H), 1.44 (m, 2H), 1.40-1.20 (m, 16H).

### 12-Bromododecylamine hydrobromide (26c)

12-amino-1-dodecanol (26b) (3.18 g, 15.8 mmol) was suspended in aqueous HBr (25 mL, 48%, 220 mmol) in a pressure vessel. The mixture was stirred at 120° C. for 16 h. The starting material was totally dissolved once heated to 120° C. After reaction the product formed a brown solid layer at the top of solution. The solid was filtered out, washed with a little water. Drying under vacuum gives 12-bromododecylamine hydrobromide (26c) as a gray solid (4.67 g, 86%). This material was used for the next step reaction without further purification. ¹H NMR (400 MHz, CD₃OD): δ 3.43 (t, J=6.8 Hz, 2H), 2.92 (t, J=7.6 Hz, 2H), 1.84 (m, 2H), 1.65 (m, 2H), 1.50-1.20 (m, 16H).

### 12-(Boc-amino)-1-dodecyl bromide (26)

To a stirred solution of 12-bromododecylamine hydrobromide (26c) (4.65 g, 13.5 mmol) in 200 mL CH₂Cl₂ at 0° C. were added di-t-butyl dicarbonate (4.2 g, 19.2 mmol) and diisopropylethyl amine (7 mL, 40 mmol). The mixture was then allowed to warm up and continue to react at room temperature for 16 h. The solvents were evaporated under vacuum, and the residue was purified by column chromatography (SiO₂, CH₂Cl₂ to 1:9 EtOAc/Hex) to give 26 as a beige solid (4.41 g, 90%). R_{f}(silica gel, 1:9 EtOAc/Hex)=0.41; ¹H NMR (400 MHz, CDCl₃): δ 4.48 (br s, NH, 1H), 3.41 (d, J=6.8 Hz, 2H), 3.10 (q, J=6.4 Hz, 2H), 1.85 (m, 2H), 1.50-1.38 (m, 13H), 1.34-1.24 (m, 14H).

### Synthesis of F2

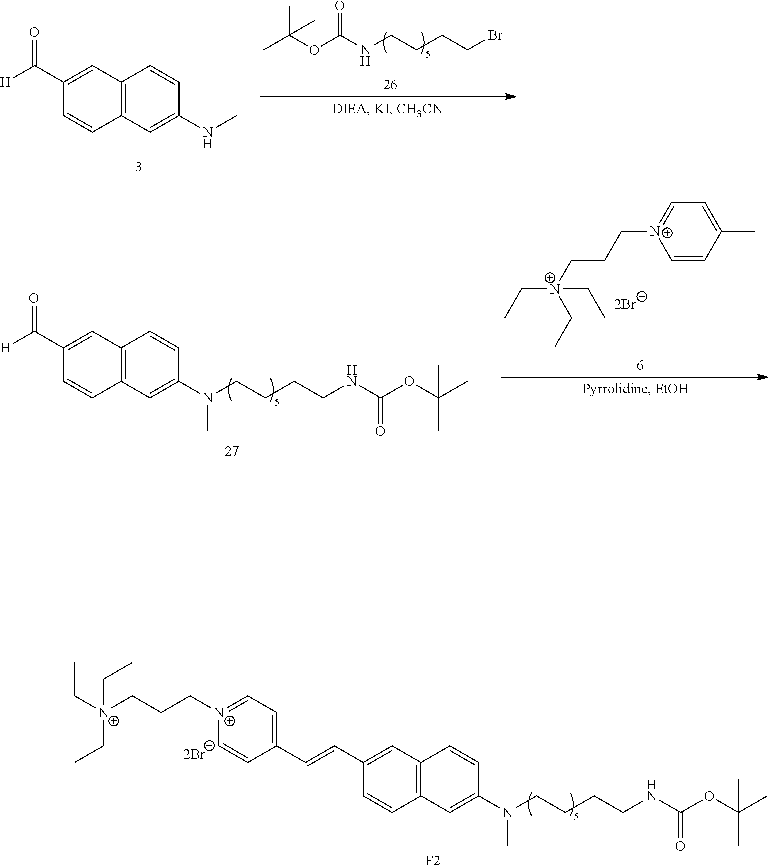

Synthesis of F2 follows that of F1, except 12-(Boc-amino)-1-dodecyl bromide (26) was used for the alkylation of 3.

### {12-[(6-Formyl-naphthalen-2-yl)-methyl-amino]-dodecyl}-carbamic acid tert-butyl ester (27)

To a pressure vessel were added 3 (377 mg, 2.0 mmol), 26 (1.2 g, 3.3 mmol), KI (663 mg, 4.0 mmol), N,N-diisopropylethylamine (1.04 mL, 6.0 mmol), and acetonitrile (5 mL). The pressure vessel was sealed and allowed to react at 130° C. for 2 days. Upon cooling down the solvents were removed under vacuum, and the residue was purified by column chromatography (SiO₂, solvent gradient: CH₂Cl₂ to 1:4 EtOAc/CH₂Cl₂) to give 27 as a yellow solid (0.81 g, 86%). R_{f}(silica gel, 1:1 EtOAc/Hexane)=0.81; ¹H NMR (400 MHz, CDCl₃): δ 9.99 (s, 1H), 8.13 (s, 1H), 7.80 (m, 2H), 7.63 (d, J=8.4 Hz, 1H), 7.14 (dd, J=2, 9 Hz, 1H), 6.83 (d, J=2 Hz, 1H), 4.50 (br s, 1H), 3.46 (t, J=7.6 Hz, 2H), 3.10 (q, J=6 Hz, 2H), 3.09 (s, 3H), 1.63 (m, 2H), 1.48-1.42 (m, 11H), 1.38-1.32 (m, 2H), 1.32-1.23 (m, 14H).

F2: A mixture of 27 (10 mg, 21 μmol), 6 (8.5 mg, 21 μmol), and pyrrolidine catalyst (20 μL) was stirred in 4 mL 1:1 EtOH/CH₂Cl₂ at room temperature for 16 hrs. The solution turned red after the reaction. The solvents were evaporated under vacuum. The residue was purified by column chromatography (SiO₂-amino, solvent gradient: CH₂Cl₂ to 1:9 MeOH/CH₂Cl₂) to give F2 as a red solid (8 mg, 44%). R_{f}(silica gel, 24:4:16:6:6 CH₂Cl₂/i-PrOH/MeOH/H₂O/HOAc)=0.33; ¹H NMR (400 MHz, CD₃OD): δ 8.80 (d, J=5.4 Hz, 2H), 8.18 (d, J=5.4 Hz, 2H), 8.08 (d, J=16 Hz, 1H), 7.97 (s, 1H), 7.77 (dd, J=1.6, 8.8 Hz, 1H), 7.76 (d, J=9.2 Hz, 1H), 7.66 (d, J=8.4 Hz, 1H), 7.39 (d, J=16 Hz, 1H), 7.22 (dd, J=2.4, 9.2 Hz, 1H), 6.91 (d, J=2.4 Hz, 1H), 4.60 (t, J=7.2 Hz, 2H), 3.51 (t, J=7.4 Hz, 2H), 3.44-3.36 (m, 8H), 3.09 (s, 3H), 3.00 (t, J=7.0 Hz, 2H), 2.46 (m, 2H), 1.65 (m, 2H), 1.42 (m, 11H), 1.40-1.25 (m, 25H).

### Synthesis of F3

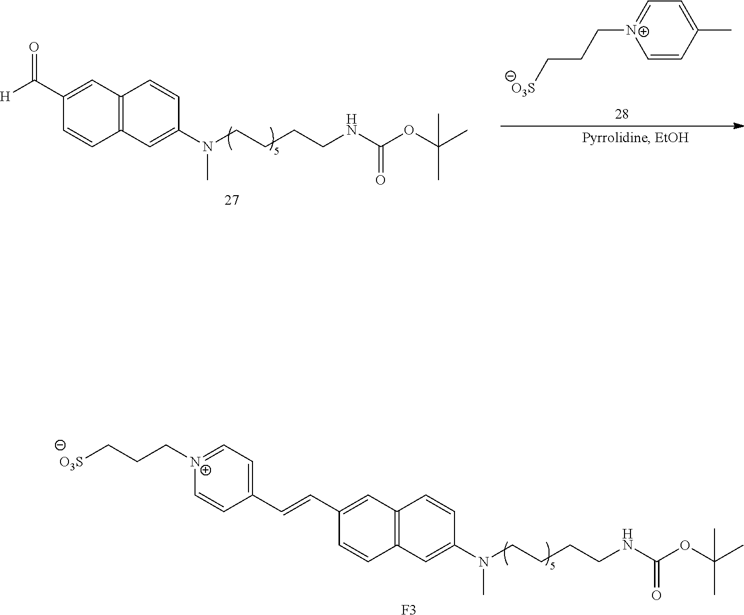

Synthesis of F3 follows that of F2, except 4-methyl-1-(3-sulfopropyl)-pyridinium inner salt (28) was used to condense with aldehyde 27.

### 4-Methyl-1-(3-sulfopropyl)-pyridinium inner salt (28)

4-Picoline (2 g, 21 mmol) and 1,3-propanesultone (1.22 g, 10 mmol) were dissolved in 5 mL CH₂Cl₂ in a 150 mL pressure vessel. The mixture was stirred at 100° C. for 2 h. A lot of white precipitates formed during the reaction. The precipitates were filtered out and washed with 10 mL more CH₂Cl₂ to give 28 as a white solid (2.06 g, 96%). ¹H NMR (400 MHz, CD₃OD): δ 8.83 (d, J=6.6 Hz, 2H), 7.93 (d, J=6.6 Hz, 2H), 4.75 (t, J=7.4 Hz, 2H), 2.83 (t, J=6.8 Hz, 2H), 2.68 (s, 3H), 2.42 (m, 2H).

F3: A mixture of 27 (10 mg, 21 μmol), 28 (4.6 mg, 21 μmol), and pyrrolidine catalyst (10 μL) was stirred in 1 mL EtOH at room temperature for 16 hrs. The solution turned deep red after the reaction. The solvents were evaporated under vacuum and the residue was purified by column chromatography (SiO₂, solvent gradient: 2:8 to 3:7 MeOH/CH₂Cl₂) to give F3 as a red solid (10 mg, 72%). R_{f}(silica gel, 24:4:16:6:6 CH₂Cl₂/i-PrOH/MeOH/H₂O/HOAc)=0.72; ¹H NMR (400 MHz, CD₃OD): δ 8.68 (d, J=7.0 Hz, 2H), 8.07 (d, J=7.0 Hz, 2H), 7.98 (d, J=16 Hz, 1H), 7.92 (s, 1H), 7.73 (d, J=9.2 Hz, 2H), 7.63 (d, J=8.4 Hz, 1H), 7.32 (d, J=16 Hz, 1H), 7.19 (dd, J=2.4, 9.2 Hz, 1H), 6.88 (d, J=2.4 Hz, 1H), 4.66 (t, J=7.4 Hz, 2H), 3.49 (t, J=7.6 Hz, 2H), 3.07 (s, 3H), 3.00 (t, J=7.0 Hz, 2H), 2.86 (t, J=7.0 Hz, 2H), 2.42 (m, 2H), 1.64 (m, 2H), 1.42 (m, 11H), 1.40-1.28 (m, 16H).

### Synthesis of F4

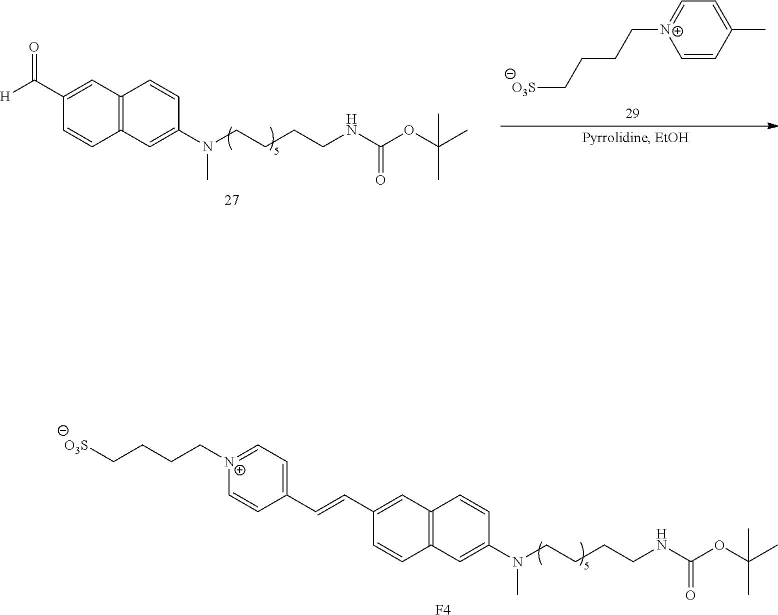

Synthesis of F4 follows that of F2, except 4-methyl-1-(4-sulfobutyl)-pyridinium inner salt (29) was used to condense with aldehyde 27.

### 4-Methyl-1-(4-sulfobutyl)-pyridinium inner salt (29)

4-Picoline (1.6 g, 17 mmol) and 1,4-butanesultone (1.36 g, 10 mmol) were dissolved in 5 mL CH₂Cl₂ in a 150 mL pressure vessel. The mixture was stirred at 100° C. for 16 h. A lot of white precipitates formed during the reaction. The precipitates were filtered out and washed with CH₂Cl₂ to give 29 as a white solid (2.04 g, 89%). ¹H NMR (400 MHz, CD₃OD): δ 8.81 (d, J=6.6 Hz, 2H), 7.92 (d, J=6.6 Hz, 2H), 4.60 (t, J=7.4 Hz, 2H), 2.86 (t, J=7.2 Hz, 2H), 2.68 (s, 3H), 2.16 (m, 2H), 1.81 (m, 2H).

F4: A mixture of 27 (100 mg, 213 μmol), 29 (55 mg, 240 μmol), and pyrrolidine catalyst (50 μL) was stirred in 5 mL EtOH at room temperature for 24 hrs. The solution turned deep red after the reaction. There are also lots of red precipitates formed. The solvents were evaporated under vacuum and the residue was purified by column chromatography (SiO₂, solvent gradient: 1:9 to 3:7 MeOH/CH₂Cl₂) to give F4 as a red solid (121 mg, 83%). R_{f}(silica gel, 24:4:16:6:6 CH₂Cl₂/i-PrOH/MeOH/H₂O/HOAc)=0.70; ¹H NMR (400 MHz, CD₃OD): δ 8.71 (d, J=7.2 Hz, 2H), 8.11 (d, J=7.2 Hz, 2H), 8.03 (d, J=16.4 Hz, 1H), 7.95 (s, 1H), 7.75 (m, 2H), 7.65 (d, J=8.8 Hz, 1H), 7.37 (d, J=16.4 Hz, 1H), 7.21 (dd, J=2.4, 9.2 Hz, 1H), 6.91 (d, J=2.4 Hz, 1H), 4.53 (t, J=7.2 Hz, 2H), 3.50 (t, J=7.6 Hz, 2H), 3.09 (s, 3H), 3.00 (t, J=7.0 Hz, 2H), 2.89 (t, J=7.2 Hz, 2H), 2.17 (m, 2H), 1.85 (m, 2H), 1.65 (m, 2H), 1.42 (m, 11H), 1.40-1.28 (m, 16H).

### Synthesis of T1

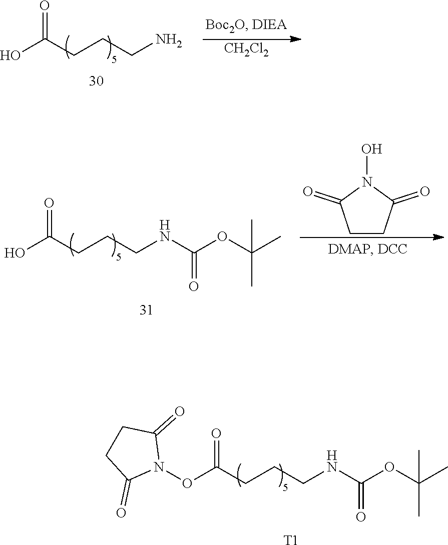

### 12-tert-Butoxycarbonylamino-dodecanoic acid (31)

To an oven-dried round bottom flask were added 12-aminododecanoic acid (30) (1 g, 4.64 mmol), N,N-diisopropylethylamine (2.43 mL, 14.0 mmol), di-tert-butyl dicarbonate (1.22 g, 5.59 mmol), and CH₂Cl₂ (50 mL) at 0° C. under N₂. The mixture was vigorously stirred and allowed to warm up to room temperature slowly overnight (16 h). After reaction the insoluble starting material, 30, disappeared. The solvents were evaporated under vacuum and the residue was purified by column chromatography (SiO₂, solvent gradient: CH₂Cl₂ to 5:95 MeOH/CH₂Cl₂) to give 31 as a white solid (927 mg, 63%). R_{f}(silica gel, 1:9 MeOH/CH₂Cl₂)=0.37; ¹H NMR (500 MHz, CDCl₃): δ 4.52 (s, 1H), 3.10 (m, 2H), 2.35 (t, J=7.2 Hz, 2H), 1.63 (m, 2H), 1.45 (m, 11H), 1.38-1.24 (m, 16H).

### 12-tert-Butoxycarbonylamino-dodecanoic acid N-hydroxy-succinimide ester (T1)

To a round bottom flask were added acid 31 (315 mg, 1 mmol), N-hydroxysuccinimide (173 mg, 1.5 mmol), DMAP (12 mg, 0.1 mmol), and 10 mL CH₂Cl₂ under N₂. The mixture was cooled down to 0° C. and then a solution of DCC (310 mg, 1.5 mmol) in 10 mL CH₂Cl₂ was added dropwise. The mixture was allowed to warm up to room temperature slowly overnight (16 h). Lots of white precipitates formed during the reaction. The precipitates were filtered off and the filtrate was washed with 10 mL 0.05 N HCl(aq) (2×). The organic layer was dried with Na₂SO₄ and concentrated under vacuum. The residue was dispersed in 10 mL EtOAc, and the insoluble precipitates were filtered off. The filtrate was concentrated to give T1 as a white solid (412 mg, 100%). ¹H NMR (500 MHz, CDCl₃): δ 4.49 (s, 1H), 3.10 (q, J=6.4 Hz, 2H), 2.83 (s, 4H), 2.60 (t, J=7.6 Hz, 2H), 1.74 (m, 2H), 1.50-1.35 (m, 13H), 1.35-1.24 (m, 14H).

### Synthesis of T2

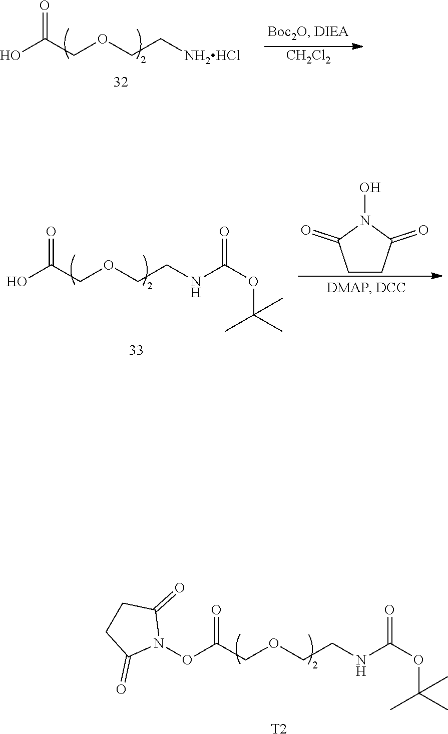

### 2-(2-(2-tert-Butoxycarbonylamino-ethoxy)-ethoxy)-acetic acid (33)

To an oven-dried round bottom flask were added 2-(2-(2-amino-ethoxy)-ethoxy)-acetic acid hydrochloride (32) (1 g, 5.0 mmol), N,N-diisopropylethylamine (2.62 mL, 15.0 mmol), di-tert-butyl dicarbonate (1.31 g, 6.0 mmol), and CH₂Cl₂ (50 mL) at 0° C. under N₂. The mixture was vigorously stirred and allowed to warm up to room temperature slowly overnight (16 h). After reaction the insoluble starting material, 32, disappeared. The solvents were evaporated under vacuum and the residue was purified by column chromatography (SiO₂, solvent gradient: CH₂Cl₂ to 1:9 MeOH/CH₂Cl₂) to give 33 as a colorless oil (640 mg, 49%). R_{f}(silica gel, 1:9 MeOH/CH₂Cl₂)=0.07; ¹H NMR (400 MHz, CDCl₃): δ 5.21 (s, 1H), 4.01 (s, 2H), 3.75-3.63 (m, 4H), 3.55 (t, J=5.0 Hz, 2H), 3.31 (br q, J=5.2 Hz, 2H), 1.44 (m, 9H).

### 2-(2-(2-tert-Butoxycarbonylamino-ethoxy)-ethoxy)-acetic acid N-hydroxy-succinimide ester (T2)

To a round bottom flask were added acid 33 (640 mg, 2.43 mmol), N-hydroxysuccinimide (419 mg, 3.64 mmol), DMAP (30 mg, 0.25 mmol), and 10 mL CH₂Cl₂ under N₂. The mixture was cooled down to 0° C. and then a solution of DCC (752 mg, 3.64 mmol) in 10 mL CH₂Cl₂ was added dropwise. The mixture was allowed to warm up to room temperature slowly overnight (16 h). Lots of white precipitates formed during the reaction. The precipitates were filtered off and the filtrate was washed with 20 mL 0.05 N HCl(aq) twice. The organic layer was dried with Na₂SO₄ and concentrated under vacuum. The residue was dispersed in 20 mL EtOAc, and the insoluble precipitates were filtered off. The filtrate was concentrated to give T2 as a colorless oil (840 mg, 96%). ¹H NMR (400 MHz, CDCl₃): δ 4.99 (s, 1H), 4.51 (s, 2H), 3.81-3.64 (m, 4H), 3.54 (t, J=5.2 Hz, 2H), 3.32 (br q, J=5.2 Hz, 2H), 2.86 (s, 4H), 1.44 (m, 9H).

### Synthesis of T3

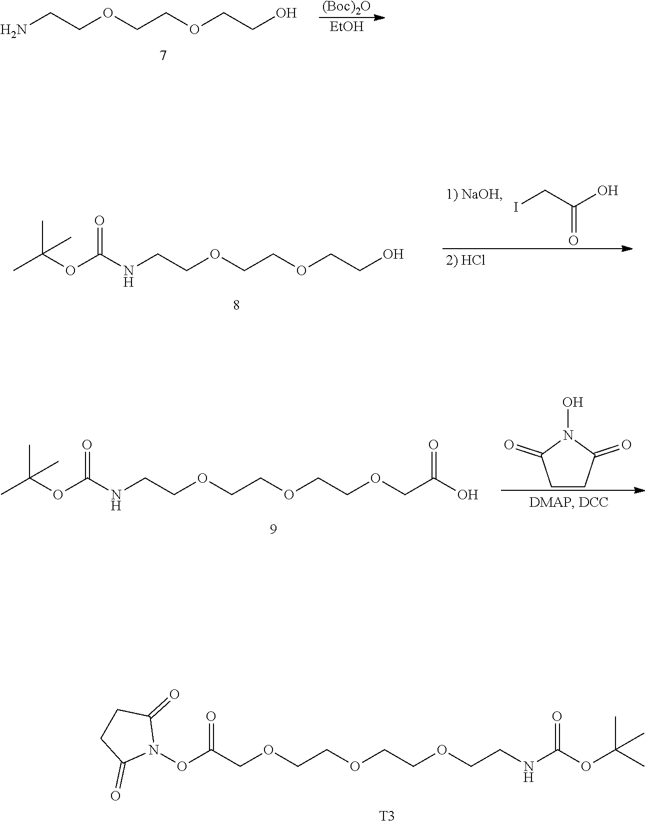

### {2-[2-(2-Hydroxy-ethoxy)-ethoxy]-ethyl}-carbamic acid tert-butyl ester (8)

2-[2-(2-Amino-ethoxy)-ethoxy]-ethanol (7) was prepared according to a literature method.^{5c} To a stirred solution of 7 (0.6 g, 4.0 mmol) in 10 mL EtOH was added a solution of di-tert-butyl dicarbonate (0.88 g, 4 mmol) in 10 mL EtOH dropwise at 0° C. under N₂. The mixture was vigorously stirred and allowed to warm up to room temperature slowly overnight (16 h). The solvents were evaporated off under vacuum to give 8 as a colorless oil (0.933 g, 94%). This material was used for the next step reaction without further purification. ¹H NMR (400 MHz, CDCl₃): δ 5.11 (s, 1H), 3.76 (m, 2H), 3.70-3.60 (m, 6H), 3.57 (t, J=5.2 Hz, 2H), 3.33 (br q, J=5.0 Hz, 2H), 2.45 (br s, 1H), 1.45 (m, 9H).

### {2-[2-(2-tert-Butoxycarbonylamino-ethoxy)-ethoxy]-ethoxy}-acetic acid (9)

To a stirred solution of 8 (1.0 g, 4 mmol) and iodoacetic acid (2.24 g, 12 mmol) in 10 mL THF were added NaOH pellets (0.96 g, 24 mmol) in one portion. The mixture was further stirred at room temperature for 2 days. The solvent was removed under vacuum, and then a solution of 0.5 g NaOH in 10 mL H₂O was added. 2×30 mL CH₂Cl₂ was used to wash the mixture. The aqueous phase was then acidified with 3N HCl solution with vigorous stirring until pH 4. Extraction with 2×30 mL CH₂Cl₂ and concentration give 9 as a yellowish oil (1.149 g, 93%). This material was used for the next step reaction without further purification. ¹H NMR (400 MHz, CDCl₃): δ 5.11 (s, 1H), 4.16 (s, 2H), 3.80-3.75 (m, 2H), 3.72-3.66 (m, 4H), 3.66-3.61 (m, 2H), 3.54 (t, J=5.2 Hz, 2H), 3.33 (br s, 2H), 1.45 (m, 9H).

### 2-{2-[2-(2-tert-Butoxycarbonylamino-ethoxy)-ethoxy]-ethoxy}-acetic acid N-hydroxy-succinimide ester (T3)

To a round bottom flask were added acid 9 (307 mg, 1.0 mmol), N-hydroxysuccinimide (173 mg, 1.5 mmol), DMAP (12 mg, 0.1 mmol), and 10 mL CH₂Cl₂ under N₂. The mixture was cooled down to 0° C. and then a solution of DCC (310 mg, 1.5 mmol) in 10 mL CH₂Cl₂ was added dropwise. The mixture was allowed to warm up to room temperature slowly overnight (16 h). Lots of white precipitates formed during the reaction. The precipitates were filtered off and the filtrate was washed with 20 mL 0.05 N HCl(aq) twice. The organic layer was dried with Na₂SO₄ and concentrated under vacuum. The residue was dispersed in 20 mL EtOAc, and the insoluble precipitates were filtered off. The filtrate was concentrated to give T3 as a colorless oil (0.4 g, 99%). ¹H NMR (400 MHz, CDCl₃): δ 5.02 (s, 1H), 4.53 (s, 2H), 3.83-3.79 (m, 2H), 3.73-3.69 (m, 2H), 3.67-3.60 (m, 4H), 3.54 (t, J=5.2 Hz, 2H), 3.31 (br q, J=5.2 Hz, 2H), 2.86 (s, 4H), 1.44 (m, 9H).

### Synthesis of Q

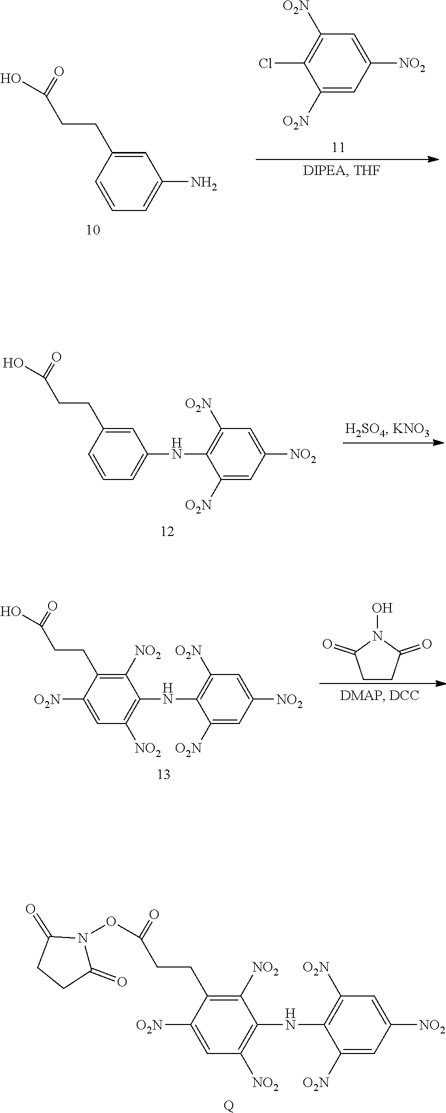

### 3-[3-(2,4,6-Trinitro-phenylamino)-phenyl]-propionic acid (12)

To a stirred solution of picryl chloride (11) (1.0 g, 4.0 mmol) in 6 mL THF was added 3-(3-amino-phenyl)-propionic acid (10) (1.0 g, 6.0 mmol). The solution turned yellow, and then solidified. Diisopropylethylamine (1.4 mL, 8.0 mmol) was then added and the solid turned into a red solution. The mixture was allowed to react at room temperature for 16 h, and then 20 mL 1N HCl was added. Oily residue formed at the bottom of the reaction flask. The organic product was extracted with ethyl acetate (20 mL×3), washed with H₂O, concentrated under vacuum to give 12 as an orange solid (1.5 g, 100%). This material was used for the next step reaction without further purification. ¹H NMR (400 MHz, DMSO-d6): δ 12.10 (br s, 1H), 10.18 (s, 1H), 8.94 (s, 2H), 7.24 (t, J=8.0 Hz, 1H), 7.07-6.99 (m, 3H), 2.74 (t, J=7.6 Hz, 2H), 2.47 (t, J=7.6 Hz, 2H).

### 3-[2,4,6-Trinitro-3-(2,4,6-trinitro-phenylamino)-phenyl]-propionic acid (13)

Acid 12 (1.01 g, 2.68 mmol) was dissolved in 5 mL conc. H₂SO₄ at 0° C., and then KNO₃ (900 mg, 8.9 mmol) was added in one portion. The mixture was allowed to warm up to RT and react for 16 h. The mixture was poured into ice water. The precipitates were filtered out, washed with water, and then dissolved in acetone. The solvents were removed under vacuum to give 13 as a yellow solid (1.38 g, 100%). This material was used for the next step reaction without further purification. ¹H NMR (400 MHz, CDCl₃+CD₃OD): δ 9.16 (s, 2H), 9.00 (s, 1H), 3.12 (t, J=8.0 Hz, 2H), 2.74 (t, J=8.0 Hz, 2H).

### 3-[2,4,6-Trinitro-3-(2,4,6-trinitro-phenylamino)-phenyl]-propionic acid N-hydroxy-succinimide ester (Q)

To a round bottom flask were added acid 13 (256 mg, 0.5 mmol), N-hydroxysuccinimide (86 mg, 0.75 mmol), DMAP (6.1 mg, 0.05 mmol), and 20 mL CH₂Cl₂ under N₂. Acid 13 was not completely dissolved. The mixture was cooled down to 0° C. and then a solution of DCC (155 mg, 0.75 mmol) in 10 mL CH₂Cl₂ was added dropwise. Now acid 13 was completely dissolved. The mixture was allowed to warm up to room temperature slowly overnight (16 h). The solution was filtered and the filtrate was washed with 2×20 mL 0.05 N HCl(aq). The organic layer was dried with Na₂SO₄ and concentrated under vacuum. The residue was dispersed in 20 mL EtOAc, and the insoluble precipitates were filtered off. The filtrate was concentrated and purified by column chromatography (SiO₂, solvent gradient: 1:9 to 1:3 MeOH/CH₂Cl₂) to give Q as a red solid (186 mg, 61%). R_{f}(silica gel, 1:9 MeOH/CH₂Cl₂)=0.13; ¹H NMR (400 MHz, CD₃OD): δ 8.97 (s, 1H), 8.76 (s, 2H), 3.22-3.16 (m, 2H), 3.10-3.04 (m, 2H), 2.85 (s, 4H).

### Example 1: General Method for Syntheses of TBFQ Dyes from Building Blocks (F1-F4, T1-T3 and Q)

All TBFQ dyes were synthesized by starting from an F block, and then connecting it to subsequent T blocks, and finally the Q block. The connecting step was carried out by deprotecting an N-BOC group and subsequent reacting with an N-hydroxysuccinimide ester: a dye (2-10 mg) was dissolved in 1 mL TFA and stirred at room temperature for 10 min, and then the TFA was removed under vacuum, the residue was dissolved in 2 mL MeOH, 100 μL DIEA was added, T or Q building block (3 equivalents) was added, the mixture was allowed to react at RT for 16 h, the solvents were removed under vacuum, and the residue was purified by column chromatography (SiO₂, CH₂Cl₂ to 2:8 MeOH/CH₂Cl₂) (Unibond amino silica gel from Analtech was used for compounds that start from F1-F2) to give the desired intermediate or TBFQ product.

### TBFQ 1 (PY6210)

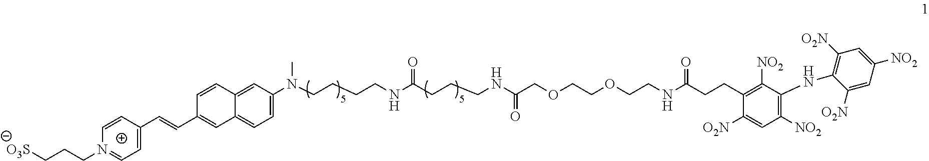

TBFQ 1 was prepared from F3, T1, T2, and Q. Yield: 47%. R_{f}(silica gel, 24:4:16:6:6 CH₂Cl₂/i-PrOH/MeOH/H₂O/HOAc)=0.88; ¹H NMR (800 MHz, DMSO-d6): δ 8.88 (d, J=6.4 Hz, 2H), 8.78 (s, 1H), 8.72 (s, 2H), 8.35 (br s, 1H), 8.18 (d, J=6.4 Hz, 2H), 8.08 (d, J=16 Hz, 1H), 8.00 (t, J=5.6 Hz, 1H), 7.97 (s, 1H), 7.79-7.75 (m, 2H), 7.70-7.66 (m, 2H), 7.62 (t, J=5.6 Hz, 1H), 7.46 (d, J=16 Hz, 1H), 7.22 (dd, J=2.0, 8.8 Hz, 1H), 6.91 (d, J=2.0 Hz, 1H), 4.61 (t, J=7.2 Hz, 2H), 3.84 (s, 2H), 3.56 (m, 4H), 3.46 (t, J=7.2 Hz, 2H), 3.43 (t, J=6.0 Hz, 2H), 3.21 (q, J=5.6 Hz, 2H), 3.07 (q, J=6.8 Hz, 2H), 3.02 (s, 3H), 2.99 (q, J=6.4 Hz, 2H), 2.93 (t, J=8.0 Hz, 2H), 2.45 (t, J=7.2 Hz, 2H), 2.43 (t, J=8.0 Hz, 2H), 2.25 (p, J=7.2 Hz, 2H), 2.00 (t, J=7.2 Hz, 2H), 1.55 (m, 2H), 1.45 (m, 2H), 1.38 (m, 2H), 1.35 (m, 2H), 1.32-1.18 (m, 30H); HRMS (ESI negative): m/z=1399.6131 [M-H]⁻ (caled for C₆₆H₈₇N₁₂O₂₀S⁻: 1399.5886).

### TBFQ 14 (PY6017)

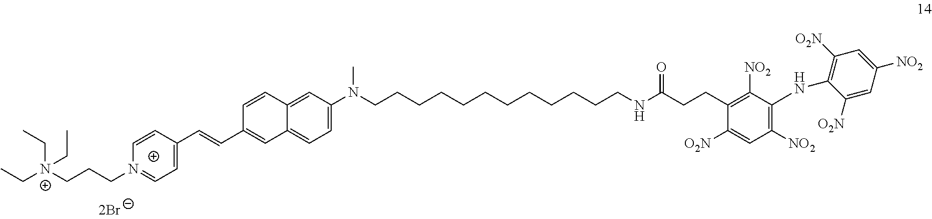 [SMILES: CC[N+](CC)(CC)CCC[n+]1ccc(/C=C/c2ccc3cc(N(C)CCCCCCCCCCCCNC(=O)CCc4c([N+](=O)[O-])cc([N+](=O)[O-])c(Nc5c([N+](=O)[O-])cc([N+](=O)[O-])cc5[N+](=O)[O-])c4[N+](=O)[O-])ccc3c2)cc1]

TBFQ 14 was prepared from F2, and Q. Yield: 33%. R_{f}(silica gel, 24:4:16:6:6 CH₂Cl₂/i-PrOH/MeOH/H₂O/HOAc)=0.45; ¹H NMR (400 MHz, DMSO-d6): δ 8.87 (d, J=5.6 Hz, 2H), 8.76 (s, 1H), 8.71 (s, 2H), 8.23 (d, J=5.6 Hz, 2H), 8.11 (d, J=16 Hz, 1H), 7.97 (s, 1H), 7.84 (t, J=5.6 Hz, 1H), 7.76 (m, 2H), 7.68 (d, J=8.8 Hz, 1H), 7.47 (d, J=16 Hz, 1H), 7.22 (dd, J=2.0, 9.2 Hz, 1H), 6.90 (d, J=2.0 Hz, 1H), 4.50 (t, J=7.2 Hz, 2H), 3.47 (t, J=6.8 Hz, 2H), 3.25 (q, J=6.8 Hz, 8H), 3.02 (s, 3H), 3.00 (t, J=5.6 Hz, 2H), 2.92 (t, J=8.0 Hz, 2H), 2.38 (t, J=8.0 Hz, 2H), 2.30 (m, 2H), 1.55 (m, 2H), 1.40-1.25 (m, 27H); HRMS (ESI positive): m/z=1078.5058 [M-H-2Br]+(caled for C₅₄H₆₈N₁₁O₁₃⁺: 1078.4993).

### TBFQ 15 (PY 6021)

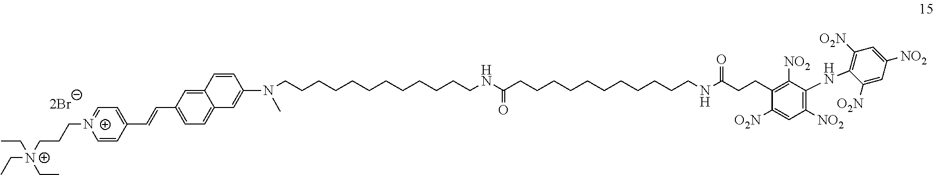 [SMILES: CC[N+](CC)(CC)CCC[n+]1ccc(/C=C/c2ccc3cc(N(C)CCCCCCCCCCCCNC(=O)CCCCCCCCCCCNC(=O)CCc4c([N+](=O)[O-])cc([N+](=O)[O-])c(Nc5c([N+](=O)[O-])cc([N+](=O)[O-])cc5[N+](=O)[O-])c4[N+](=O)[O-])ccc3c2)cc1]

TBFQ 15 was prepared from F2, T1, and Q. Yield: 90%. R_{f}(silica gel, 24:4:16:6:6 CH₂Cl₂/i-PrOH/MeOH/H₂O/HOAc)=0.43; ¹H NMR (400 MHz, DMSO-d6): δ 8.87 (d, J=6.4 Hz, 2H), 8.76 (s, 1H), 8.71 (s, 2H), 8.23 (d, J=6.4 Hz, 2H), 8.11 (d, J=16 Hz, 1H), 7.97 (s, 1H), 7.84 (t, J=5.2 Hz, 1H), 7.76 (m, 2H), 7.69 (m, 2H), 7.47 (d, J=16 Hz, 1H), 7.22 (dd, J=2.0, 9.2 Hz, 1H), 6.90 (d, J=2.0 Hz, 1H), 4.51 (t, J=7.2 Hz, 2H), 3.47 (t, J=7.6 Hz, 2H), 3.25 (q, J=7.2 Hz, 8H), 3.03 (s, 3H), 3.00 (m, 4H), 2.92 (t, J=8.0 Hz, 2H), 2.39 (t, J=8.0 Hz, 2H), 2.30 (m, 2H), 2.01 (t, J=7.2 Hz, 2H), 1.55 (m, 2H), 1.46 (m, 2H), 1.40-1.14 (m, 43H); HRMS (ESI positive): m/z=1275.6664 [M-H-2Br]+(caled for C₆₆H₉₁N₁₂O₁₄⁺: 1275.6772).

### TBFQ 16 (PY6084)

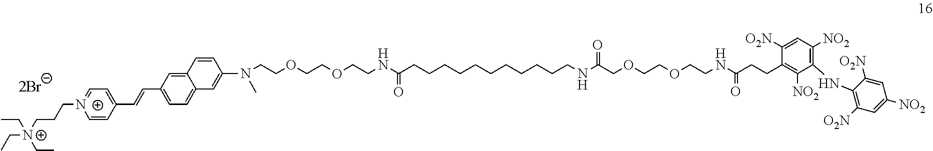 [SMILES: CC[N+](CC)(CC)CCC[n+]1ccc(/C=C/c2ccc3cc(N(C)CCOCCOCCNC(=O)CCCCCCCCCCCNC(=O)COCCOCCNC(=O)CCc4c([N+](=O)[O-])cc([N+](=O)[O-])c(Nc5c([N+](=O)[O-])cc([N+](=O)[O-])cc5[N+](=O)[O-])c4[N+](=O)[O-])ccc3c2)cc1]

TBFQ 16 was prepared from F1, T, T2, and Q. Yield: 85%. R_{f}(silica gel, 24:4:16:6:6 CH₂Cl₂/i-PrOH/MeOH/H₂O/HOAc)=0.31; ¹H NMR (400 MHz, CD₃OD): δ 8.76 (s, 1H), 8.71 (d, J=6.4 Hz, 2H), 8.56 (s, 2H), 8.11 (d, J=6.4 Hz, 2H), 7.93 (d, J=16 Hz, 1H), 7.84 (s, 1H), 7.68 (d, J=9.2 Hz, 1H), 7.64 (dd, J=2.0, 8.8 Hz, 1H), 7.58 (d, J=8.8 Hz, 1H), 7.26 (d, J=16.0 Hz, 1H), 7.22 (dd, J=2.0, 8.8 Hz, 1H), 6.91 (d, J=2.0 Hz, 1H), 4.58 (br t, 2H), 3.97 (s, 2H), 3.76 (m, 2H), 3.71 (m, 2H), 3.65 (m, 8H), 3.56 (m, 2H), 3.50 (t, J=5.2 Hz, 2H), 3.38 (m, 8H), 3.16 (t, J=8.0 Hz, 2H), 3.14 (s, 3H), 2.88 (t, J=8.0 Hz, 2H), 2.53 (t, J=8.0 Hz, 2H), 2.45 (m, 2H), 2.08 (t, J=7.6 Hz, 2H), 1.61 (m, 2H), 1.51 (m, 2H), 1.45-1.14 (m, 23H); HRMS (ESI positive): m/z=1370.6486 [M-H-2Br]+(caled for C₆₆H₈₈D₂N₁₃O₁₉⁺: 1370.6594).

### TBFQ 17 (PY6086)

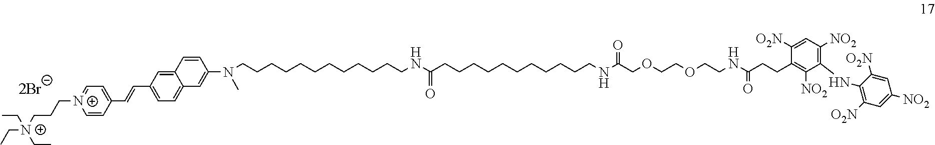 [SMILES: CC[N+](CC)(CC)CCC[n+]1ccc(/C=C/c2ccc3cc(N(C)CCCCCCCCCCCCNC(=O)CCCCCCCCCCCNC(=O)COCCOCCNC(=O)CCc4c([N+](=O)[O-])cc([N+](=O)[O-])c(Nc5c([N+](=O)[O-])cc([N+](=O)[O-])cc5[N+](=O)[O-])c4[N+](=O)[O-])ccc3c2)cc1]

TBFQ 17 was prepared from F2, T1, T2, and Q. Yield: 37%. R_{f}(silica gel, 24:4:16:6:6 CH₂Cl₂/i-PrOH/MeOH/H₂O/HOAc)=0.34; ¹H NMR (400 MHz, DMSO-d6): δ 8.87 (d, J=6.4 Hz, 2H), 8.77 (s, 1H), 8.71 (s, 2H), 8.22 (d, J=6.4 Hz, 2H), 8.11 (d, J=16 Hz, 1H), 7.99 (t, J=5.6 Hz, 1H), 7.97 (s, 1H), 7.76 (m, 2H), 7.69 (m, 2H), 7.61 (t, J=5.6 Hz, 1H), 7.47 (d, J=16 Hz, 1H), 7.21 (dd, J=2.0, 9.2 Hz, 1H), 6.90 (d, J=2.0 Hz, 1H), 4.51 (t, J=7.2 Hz, 2H), 3.84 (s, 2H), 3.55 (s, 4H), 3.46 (t, J=7.2 Hz, 2H), 3.43 (t, J=6.0 Hz, 2H), 3.25 (m, 8H), 3.21 (q, J=5.6 Hz, 2H), 3.06 (q, J=6.8 Hz, 2H), 3.03 (s, 3H), 2.99 (q, J=6.4 Hz, 2H), 2.92 (t, J=8.0 Hz, 2H), 2.42 (t, J=8.0 Hz, 2H), 2.29 (m, 2H), 2.00 (t, J=7.2 Hz, 2H), 1.54 (m, 2H), 1.44 (m, 2H), 1.36 (m, 4H), 1.30-1.10 (m, 39H); HRMS (ESI positive): m/z=1420.7404 [M-H-2Br]+(caled for C₇₂H₁₀₂N₁₃O₁₇⁺: 1420.7511).

### TBFQ 18 (PY6128)

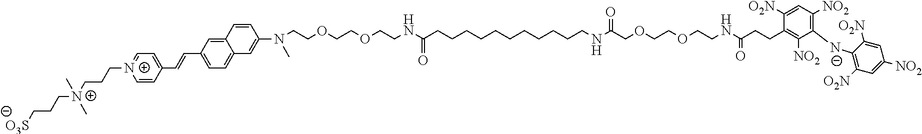

TBFQ 18 was prepared in a similar way to 16. Yield: 95%. R_{f}(silica gel, 24:4:16:6:6 CH₂Cl₂/i-PrOH/MeOH/H₂O/HOAc)=0.40; ¹H NMR (800 MHz, DMSO-d6): δ 8.90 (d, J=5.2 Hz, 2H), 8.77 (s, 1H), 8.71 (s, 2H), 8.22 (d, J=5.2 Hz, 2H), 8.12 (d, J=16 Hz, 1H), 7.98 (m, 2H), 7.76 (m, 3H), 7.69 (d, J=8.0 Hz, 1H), 7.61 (br t, 1H), 7.47 (d, J=16 Hz, 1H), 7.25 (d, J=8.8 Hz, 1H), 6.95 (s, 1H), 4.58 (br t, 2H), 3.84 (s, 2H), 3.70-3.40 (m, 20H), 3.21 (m, 2H), 3.15 (m, 2H), 3.09-3.01 (m, 11H), 2.92 (br t, 2H), 2.42 (m, 4H), 2.08 (m, 4H), 1.44 (m, 2H), 1.37 (m, 4H), 1.28-1.14 (m, 14H); HRMS (ESI negative): m/z=1546.6072 [M+CF₃COO]⁻ (caled for C₆₇H₈₇F₃N₁₃O₂₄S⁻: 1546.5665).

### TBFQ 19 (PY 6221)

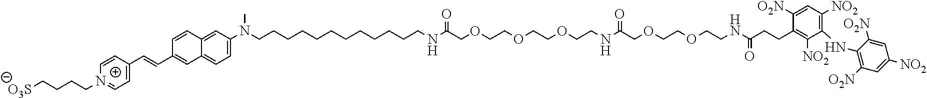

TBFQ 19 was prepared from F4, T3, T2, and Q. Yield: 15%. R_{f}(silica gel, 24:4:16:6:6 CH₂Cl₂/i-PrOH/MeOH/H₂O/HOAc)=0.84; ¹H NMR (500 MHz, DMSO-d6): δ 8.87 (d, J=6.5 Hz, 2H), 8.77 (s, 1H), 8.71 (s, 2H), 8.19 (d, J=6.5 Hz, 2H), 8.07 (d, J=16 Hz, 1H), 7.98 (t, J=5.5 Hz, 1H), 7.97 (s, 1H), 7.76 (m, 2H), 7.68 (d, J=8.5 Hz, 1H), 7.62 (m, 2H), 7.45 (d, J=16 Hz, 1H), 7.21 (br d, J=8.5 Hz, 1H), 6.90 (s, 1H), 4.49 (t, J=7.0 Hz, 2H), 3.86 (s, 2H), 3.84 (s, 2H), 3.60-3.10 (m, 16H), 3.26 (q, J=5.5 Hz, 2H), 3.21 (q, J=5.5 Hz, 2H), 3.07 (q, J=6.5 Hz, 2H), 3.02 (s, 3H), 2.92 (q, J=8.0 Hz, 2H), 2.42 (t, J=8.0 Hz, 2H), 2.00 (m, 2H), 1.64-1.50 (m, 4H), 1.38 (m, 2H), 1.34 (m, 2H), 1.32-1.12 (m, 16H); HRMS (ESI negative): m/z=1405.5809 [M-H]⁻ (caled for C₆₃H₈₁N₁₂O₂₃S⁻: 1405.5264).

### TBFQ 20 (PY 6225)

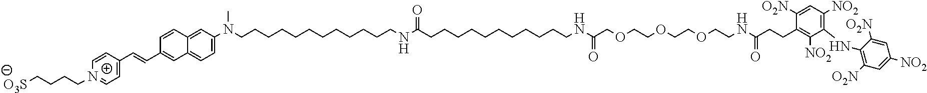

TBFQ 20 was prepared from F4, T1, T3, and Q. Yield: 42%. R_{f}(silica gel, 24:4:16:6:6 CH₂Cl₂/i-PrOH/MeOH/H₂O/HOAc)=0.78; ¹H NMR (500 MHz, DMSO-d6): δ 8.88 (d, J=6.2 Hz, 2H), 8.77 (s, 1H), 8.71 (s, 2H), 8.18 (d, J=6.2 Hz, 2H), 8.09 (d, J=16 Hz, 1H), 7.97 (m, 2H), 7.76 (m, 2H), 7.68 (m, 2H), 7.62 (t, J=5.5 Hz, 1H), 7.46 (d, J=16 Hz, 1H), 7.21 (br d, J=8.0 Hz, 1H), 6.91 (s, 1H), 4.49 (t, J=7.0 Hz, 2H), 3.84 (s, 2H), 3.56 (s, 4H), 3.54-3.44 (m, 4H), 3.20 (q, J=5.5 Hz, 2H), 3.06 (q, J=6.5 Hz, 2H), 3.02 (s, 3H), 2.99 (q, J=6.0 Hz, 2H), 2.92 (q, J=8.0 Hz, 2H), 2.42 (q, J=8.0 Hz, 2H), 2.00 (m, 4H), 1.64-1.50 (m, 4H), 1.45 (m, 2H), 1.38 (m, 2H), 1.34 (m, 2H), 1.32-1.12 (m, 30H); HRMS (ESI negative): m/z=1457.7619 [M-H]⁻ (caled for C₆₉H₉₃N₁₂O₂₁S⁻: 1457.6304).

### TBFQ 21(PY6227)

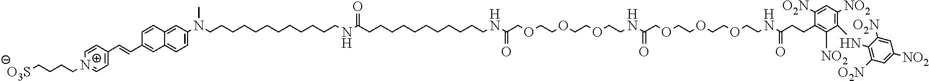

TBFQ 21 was prepared from F4, T1, T3, T3 and Q. Yield: 14%. R_{f}(silica gel, 24:4:16:6:6 CH₂Cl₂/i-PrOH/MeOH/H₂O/HOAc)=0.68; ¹H NMR (500 MHz, DMSO-d6): δ 8.88 (d, J=6.5 Hz, 2H), 8.77 (s, 1H), 8.71 (s, 2H), 8.18 (d, J=6.5 Hz, 2H), 8.09 (d, J=16 Hz, 1H), 7.97 (m, 2H), 7.76 (m, 2H), 7.71-7.59 (m, 4H), 7.46 (d, J=16 Hz, 1H), 7.21 (d, J=9.0 Hz, 1H), 6.91 (s, 1H), 4.49 (t, J=7.0 Hz, 2H), 3.86 (s, 2H), 3.84 (s, 2H), 3.70-3.40 (m, 22H), 3.26 (q, J=7.0 Hz, 2H), 3.20 (q, J=5.5 Hz, 2H), 3.06 (q, J=7.0 Hz, 2H), 3.02 (s, 3H), 2.99 (q, J=6.0 Hz, 2H), 2.92 (q, J=8.0 Hz, 2H), 2.42 (q, J=8.0 Hz, 2H), 2.00 (m, 4H), 1.75-1.00 (m, 40H); HRMS (ESI negative): m/z=1646.9219 [M-H]⁻ (caled for C₇₇H₁₀₈N₁₃O₂₅S⁻: 1646.7306).

### TBFQ 22 (PY 6229)

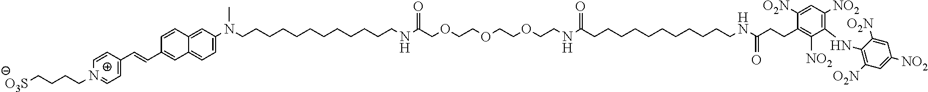

TBFQ 22 was prepared from F4, T3, T1, and Q. Yield: 10%. R_{f}(silica gel, 24:4:16:6:6 CH₂Cl₂/i-PrOH/MeOH/H₂O/HOAc)=0.74; ¹H NMR (500 MHz, DMSO-d6): δ 8.88 (d, J=6.2 Hz, 2H), 8.77 (s, 1H), 8.71 (s, 2H), 8.18 (d, J=6.2 Hz, 2H), 8.09 (d, J=16 Hz, 1H), 7.97 (m, 2H), 7.76 (m, 2H), 7.68 (m, 2H), 7.62 (t, J=5.5 Hz, 1H), 7.46 (d, J=16 Hz, 1H), 7.21 (br d, J=8.0 Hz, 1H), 6.91 (s, 1H), 4.49 (t, J=7.0 Hz, 2H), 3.84 (s, 2H), 3.65-3.40 (m, 12H), 3.16 (q, J=6.0 Hz, 2H), 3.06 (q, J=7.0 Hz, 2H), 3.02 (m, 5H), 2.91 (t, J=8.0 Hz, 2H), 2.38 (t, J=8.0 Hz, 2H), 2.02 (m, 4H), 1.59 (m, 2H), 1.54 (m, 2H), 1.44 (m, 2H), 1.42-1.10 (m, 34H); HRMS (ESI negative): m/z=1457.8343 [M-H]⁻ (caled for C₆₉H₉₃N₁₂O₂₁S⁻: 1457.6304).

### TBFQ 23 (PY6254)

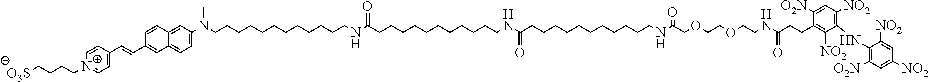

TBFQ 23 was prepared from F4, T1, T1, T2 and Q. Yield: 25%. R_{f}(silica gel, 24:4:16:6:6 CH₂Cl₂/i-PrOH/MeOH/H₂O/HOAc)=0.70; ¹H NMR (500 MHz, DMSO-d6): δ 8.88 (d, J=6.5 Hz, 2H), 8.77 (s, 1H), 8.71 (s, 2H), 8.18 (d, J=6.5 Hz, 2H), 8.09 (d, J=16 Hz, 1H), 7.97 (m, 2H), 7.76 (m, 2H), 7.68 (m, 3H), 7.62 (t, J=5.5 Hz, 1H), 7.46 (d, J=16 Hz, 1H), 7.21 (d, J=7.6 Hz, 1H), 6.91 (s, 1H), 4.49 (t, J=7.0 Hz, 2H), 3.84 (s, 2H), 3.55 (s, 4H), 3.49-3.42 (m, 4H), 3.22 (q, J=6.0 Hz, 2H), 3.06 (q, J=6.5 Hz, 2H), 3.02 (s, 3H), 2.99 (m, 4H), 2.93 (t, J=8.5 Hz, 2H), 2.43 (t, J=8.5 Hz, 2H), 2.02 (m, 6H), 1.59 (m, 4H), 1.45 (m, 4H), 1.42-1.10 (m, 50H); HRMS (ESI negative): m/z=1610.9754 [M-H]⁻ (caled for C₇₉H₁₂N₁₃O₂₁S⁻: 1610.7822).

### TBFQ 24 (PY6255)

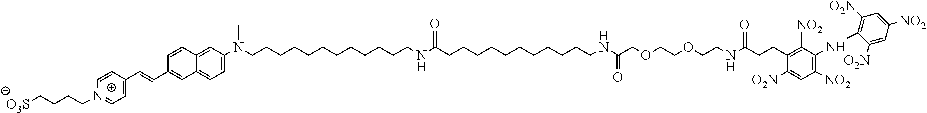

TBFQ 24 was prepared from F4, T1, T2 and Q. Yield: 14%. R_{f}(silica gel, 24:4:16:6:6 CH₂Cl₂/i-PrOH/MeOH/H₂O/HOAc)=0.81; ¹H NMR (500 MHz, DMSO-d6): δ 8.88 (d, J=6.5 Hz, 2H), 8.77 (s, 1H), 8.71 (s, 2H), 8.18 (d, J=6.5 Hz, 2H), 8.08 (d, J=16 Hz, 1H), 7.97 (m, 2H), 7.76 (m, 2H), 7.68 (m, 2H), 7.61 (t, J=5.5 Hz, 1H), 7.45 (d, J=16 Hz, 1H), 7.21 (d, J=8.0 Hz, 1H), 6.90 (s, 1H), 4.49 (t, J=7.0 Hz, 2H), 3.84 (s, 2H), 3.55 (s, 4H), 3.49-3.40 (m, 4H), 3.21 (q, J=5.5 Hz, 2H), 3.06 (q, J=6.5 Hz, 2H), 3.02 (s, 3H), 2.99 (q, J=6.5 Hz, 2H), 2.93 (t, J=8.0 Hz, 2H), 2.42 (t, J=8.0 Hz, 2H), 2.00 (m, 4H), 1.59 (m, 4H), 1.45 (m, 2H), 1.42-1.10 (m, 34H); HRMS (ESI negative): m/z=1413.7718 [M-H]⁻ (caled for C₆₇H₈₉N₁₂O₂₀S⁻: 1413.6042).

### TBFQ 25 (PY6257)

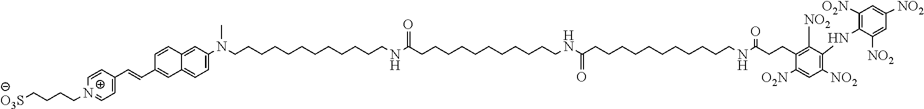

TBFQ 25 was prepared from F4, T1, T1, and Q. Yield: 23%. R_{f}(silica gel, 24:4:16:6:6 CH₂Cl₂/i-PrOH/MeOH/H₂O/HOAc)=0.91; ¹H NMR (500 MHz, DMSO-d6): δ 8.88 (d, J=6.5 Hz, 2H), 8.77 (s, 1H), 8.71 (s, 2H), 8.19 (d, J=6.5 Hz, 2H), 8.08 (d, J=16 Hz, 1H), 7.97 (s, 1H), 7.85 (t, J=5.0 Hz, 1H), 7.76 (m, 2H), 7.68 (m, 3H), 7.45 (d, J=16 Hz, 1H), 7.21 (d, J=8.5 Hz, 1H), 6.90 (s, 1H), 4.49 (t, J=7.0 Hz, 2H), 3.46 (t, J=7.0 Hz, 2H), 3.02 (s, 3H), 2.99 (m, 6H), 2.92 (t, J=8.0 Hz, 2H), 2.39 (t, J=8.0 Hz, 2H), 2.00 (m, 6H), 1.59 (m, 4H), 1.45 (m, 4H), 1.42-1.10 (m, 50H); HRMS (ESI negative): m/z=1465.8853 [M-H]⁻ (caled for C₇₃H₁₀₁N₁₂O₁₈S⁻: 1465.7083).

It is to be understood that all compounds disclosed herein and all compounds that may be made by the disclosed synthetic methods and schemes also include all biologically acceptable salts of those compounds.

Included are the following aspects:

Aspect 1. A compound of Formula (1): FP-T-Q Formula (1) and biologically acceptable salts thereof, wherein FP is a first chromophore; Q is a second chromophore; and T is a membrane-spanning tether.

Aspect 2. The compound of Aspect 1, wherein the first chromophore FP is a fluorophore and the second chromophore Q is a dye compound that quenches the fluorescence of the first chromophore by fluorescence resonance energy transfer (FRET) or another quenching mechanism.

Aspect 3. The compound of Aspect 2, wherein the first chromophore FP is a fluorophore that is a fluorescent dye functionalized with a non-permeant sidechain, wherein the fluorescent dye is a derivative of a fluorescein, a rhodamine, a cyanine, a hemicyanine, or an oxonol; and the second chromophore Q is an anionic chromophore.

Aspect 4. The compound of any one of Aspects 1-3, wherein the first chromophore FP has the structure FP-1:

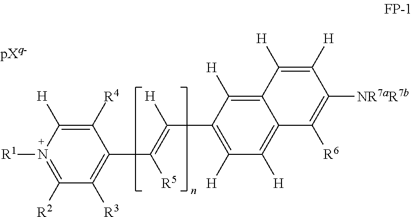

wherein p is 0, 1, or 2; X^{q-} is an anionic counterion having a charge, q, that is 1 or 2; n is 1 or 2; R¹ is an optionally substituted C₁-C₁₂ alkyl; R² is hydrogen, and R³ is hydrogen or fluorine; or R² and R³ collectively form a divalent —CH═CH—CH═CH— group; R⁴ and each occurrence of R⁵ are each independently hydrogen or fluorine; R⁶ is hydrogen or fluorine or trifluoromethyl; R^{7a} is independently C₁-C₆ alkyl; and R^{7b} is a bond linking to T, the membrane-spanning tether.

Aspect 5. The compound of Aspect 4, wherein R¹ is —CH₂CH(OH)CH₂N⁺(CH₃)₂(CH₂CH₂OH); —(CH₂)₃SO₃⁻; —(CH₂)₄SO₃⁻; —(CH₂)₃—N⁺(R⁸)₃ wherein each occurrence of R⁸ is independently C₁-C₆ alkyl or C₁-C₄—SO₃⁻; —(CH₂)₂—N⁺(R⁹)₃ wherein each occurrence of R⁹ is independently C₁-C₆ alkyl or C₁-C₄—SO₃⁻; or —CH₂CH₂OCH₂CH₂OCH₂CH₂OH.

Aspect 6. The compound of Aspect 4 or 5, wherein X^{q-} is Br⁻.

Aspect 7. The compound of any one of Aspects 4-6, wherein n is 1.

Aspect 8. The compound of any one of Aspects 4-7, wherein R², R³, R⁴, R⁵, and R⁶ are hydrogen.

Aspect 9. The compound of any one of Aspects 4-8, wherein R^{7a} is methyl.

Aspect 10. The compound of any one of Aspects 1-3, wherein the first chromophore FP is a substituted or unsubstituted cyanine dye fluorophore or derivative thereof, specifically a Cy3, Cy3.5, Cy5, Cy5.5, Cy7, or Cy7.5 derivative.

Aspect 11. The compound of any one of Aspects 1-10, wherein the second chromophore Q has the structure Q-1, Q-2, or Q-3:

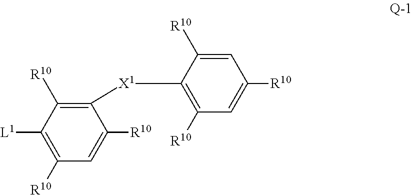

wherein X¹ is N—H or N⁻; each R¹⁰ is hydrogen or —NO₂, specifically —NO₂; and

L¹ is a group linking to T, the membrane-spanning tether;

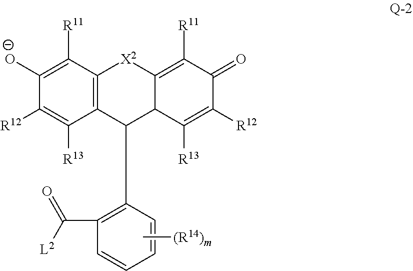

wherein X² is absent, O, S, or Si(CH₃)₂; R¹¹ is H, Br, Cl, or I; each R¹² and R¹³ independently is H, Br, Cl, NO₂, or I, or R¹² and R¹³ together form a divalent —CH═CH—CH═CH— group;

R¹⁴ is H, C₁-C₁₀ alkyl, halogen, C₁-C₁₀ alkoxy, C₆-C₁₂ aryl, C₃-C₁₁ cycloalkyl, C₁-C₁₀ alkylthio, or C₁-C₁₀ haloalkyl; m is 0, 1, or 2; and L² is a group linking to T, the membrane-spanning tether of Formula (1);

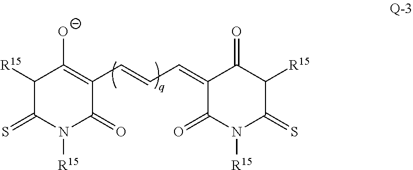

wherein q is 0, 1, or 2; each R¹⁵ is independently C₁-C₁₂ alkyl, H, Br, Cl, I or NO₂ with the proviso that one R¹⁵ is L³ a group linking to T, the membrane-spanning tether of Formula (1).

Aspect 12. The compound of Aspect 11, wherein every instance of R¹⁰ is —NO₂.

Aspect 13. The compound of Aspect 11 or 12, wherein L¹ is a bond, an amide group, an ether group, a carbamate group, a carbonate group, a substituted or unsubstituted carbohydryl chain, or a combination thereof, L² is a bond, an amide group, an ether group, a carbamate group, a sulfonate group, a carbonate group, a substituted or unsubstituted C₁-C₁₀ carbohydryl chain, or a combination thereof; and L³ is a bond, an amide group, an ether group, a carbamate group, a sulfonate group, a carbonate group, a substituted or unsubstituted C₁-C₁₀ carbohydryl chain, or a combination thereof.

Aspect 14. The compound of any one of Aspects 1-13, wherein the second chromophore Q is a bromocresol derivative.

Aspect 15. The compound of any one of Aspects 1-14, wherein the membrane-spanning tether T comprises about 29 to about 35, specifically about 30 to about 34, more specifically about 31 to about 33, and yet more specifically about 32 linker atoms in length, wherein each linker atom may be a carbon, oxygen, or nitrogen.

Aspect 16. The compound of any one of Aspects 1-15, wherein the membrane-spanning tether T comprises about 0 to about 6 ether groups, specifically about 2 to about 4 ether groups; about 0 to about 6 amide groups, specifically about 2 to about 4 amide groups; about 0 to about 6 polyethylene glycol groups, specifically about 2 to about 4 polyethylene glycol groups; or a combination thereof.

Aspect 17. The compound of any one of Aspects 1-14, wherein the membrane-spanning tether T is —(CH₂CH₂)₂CH₂CH₂NH(C═O)—(CH₂)₁₁—NH(C═O)CH₂—(OCH₂CH₂)₂—NH(C═O)—CH₂CH₂—; —(CH₂)₁₂—NH(C═O)—(CH₂)₁₁—NH(C═O)CH₂—(OCH₂CH₂)₂—NH(C═O)—CH₂CH₂—; or —(CH₂)₁₂—NH(C═O)—(CH₂)₁₁—NH(C═O)—CH₂CH₂—.

Aspect 18. The compound of Aspect 1, which is a compound from Table 1, herein.

Aspect 19. A method for ion channel drug screening, screening drugs for cardiac toxicology, non-invasive imaging of electrical activity in human brain and heart, photoacoustic imaging for recording electrical activity deep in tissues, or a combination thereof comprising using one or more of the compounds of any one of Aspects 1-18.

### REFERENCES IN THE GENERAL FIELD

Gonzalez, J. E., and R. Y. Tsien. 1995. Voltage sensing by fluorescence resonance energy transfer in single cells. Biophysical journal 69:1272-1280.
Gonzalez, J. E., and R. Y. Tsien. 1997. Improved indicators of membrane potential that use fluorescence resonance energy transfer. Chemistry and Biology 4:269-277.
Bradley J, Luo R, Otis T S, DiGregorio D A. Submillisecond Optical Reporting of Membrane Potential In Situ Using a Neuronal Tracer Dye. J Neurosci. 2009; 29(29):9197-209. doi: 10.1523/jneurosci.1240-09.2009.

All patents, published patent applications and other documents cited herein and the following listed documents and all referenced publications cited therein, and the descriptions and information contained in these documents are expressly incorporated herein in their entirety to the same extent as if each document or cited publication was individually and expressly incorporated herein.
1. Leslie M. Loew Unpublished document entitled “Supplemental information from grant proposals on Tethered bichromophoric voltage-sensitive dyes (VSDs)” [5 pages].
2. Joseph P. Wuskell et al. “Synthesis, spectra, delivery and potentiometric responses of new styryl dyes with extended spectral ranges” Journal of Neuroscience Methods 151 (2006) 200-215. [16 pages].

If a term in the present application contradicts or conflicts with a term in an incorporated reference, the term from the present application takes precedence over the conflicting term from the incorporated reference.

While the invention has been described with reference to preferred embodiments, it will be understood by those skilled in the art that various changes may be made and equivalents may be substituted for the elements thereof without departing from the scope of the invention. In addition, many modifications may be made to adapt the teaching of the invention to particular use, application, manufacturing conditions, use conditions, composition, medium, size, and/or materials without departing from the essential scope and spirit of the invention. Therefore, it is intended that the invention not be limited to the particular embodiments and best mode contemplated for carrying out this invention as described herein.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and words of a similar nature in the context of describing the improvements disclosed herein (especially in the context of the following claims) are to be construed to cover both the singular and the plural, unless otherwise indicated herein or clearly contradicted by context. Further, it should further be noted that the terms “first,” “second,” and the like herein do not denote any order, quantity, or relative importance, but rather are used to distinguish one element from another. The modifier “about” used in connection with a quantity is inclusive of the stated value and has the meaning dictated by the context (e.g., it includes, at a minimum the degree of error associated with measurement of the particular quantity).

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed.

Chemical compounds are described using standard nomenclature. Unless defined otherwise, all technical and scientific terms used herein have the same meaning as is commonly understood by one of skill in the art to which this invention belongs. Structures and formulas include all subformulae thereof. For example, formulas and compound structures include acceptable salts, prodrugs and other derivatives, hydrates, polymorphs thereof. All forms (for example solvates, optical isomers, enantiomeric forms, polymorphs, free compound and salts) of an active agent may be employed either alone or in combination.

A stable compound or chemically feasible compound is one in which the chemical structure is not substantially altered when kept at a temperature from about −80° C. to about +40° C., in the absence of moisture or other chemically reactive conditions, for at least a week, or a compound which maintains its integrity long enough to be useful.

In certain situations, the compounds of the Formulas may contain one or more asymmetric elements such as stereogenic centers, including chiral centers, stereogenic axes and the like, e.g. asymmetric carbon atoms, so that the compounds can exist in different stereoisomeric forms. These compounds can be, for example, racemates or optically active forms. For compounds with two or more asymmetric elements, these compounds can additionally be mixtures of diastereomers. For compounds having asymmetric centers, it should be understood that all of the optical isomers and mixtures thereof are encompassed. In addition, compounds with carbon-carbon double bonds may occur in Z- and E-forms, with all isomeric forms of the compounds being included in the present invention.

“Biologically acceptable salts” include derivatives of the disclosed compounds in which the parent compound is modified by making inorganic and organic, non-toxic, acid or base addition salts thereof. The salts of the present compounds can be synthesized from a parent compound that contains a basic or acidic moiety by conventional chemical methods.

Generally, such salts can be prepared by reacting free acid forms of these compounds with a stoichiometric amount of the appropriate base (such as Na, Ca, Mg, or K hydroxide, carbonate, bicarbonate, or the like), or by reacting free base forms of these compounds with a stoichiometric amount of the appropriate acid. Such reactions are typically carried out in water or in an organic solvent, or in a mixture of the two. Salts of the present compounds further include solvates of the compounds and of the compound salts.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A compound of Formula (1):
FP-T-Q Formula (1)
and biologically acceptable salts thereof,
wherein
FP is a first chromophore;
Q is a second chromophore; and
T is a membrane-spanning tether.

2. The compound of claim 1, wherein the first chromophore FP is a fluorophore and the second chromophore Q is a dye compound that quenches the fluorescence of the first chromophore by fluorescence resonance energy transfer (FRET) or another quenching mechanism.

3. The compound of claim 2, wherein
the first chromophore FP is a fluorophore that is a fluorescent dye functionalized with a non-permeant sidechain, wherein the fluorescent dye is a derivative of a fluorescein, a rhodamine, a cyanine, a hemicyanine, or an oxonol; and
the second chromophore Q is an anionic chromophore.

4. The compound of claim 1, wherein the first chromophore FP has the structure FP-1: 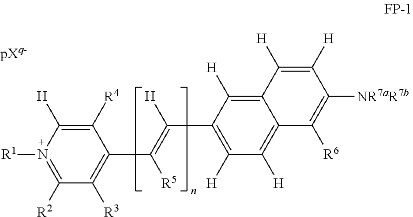
wherein
p is 0, 1, or 2; X^{q-} is an anionic counterion having a charge, q, that is 1 or 2;
n is 1 or 2;
R¹ is an optionally substituted C₁-C₁₂ alkyl;
R² is hydrogen, and R³ is hydrogen or fluorine; or R² and R³ collectively form a divalent —CH═CH—CH═CH— group;
R⁴ and each occurrence of R⁵ are each independently hydrogen or fluorine;
R⁶ is hydrogen or fluorine or trifluoromethyl;
R^{7a} is independently C₁-C₆ alkyl; and
R^{7b} is a bond linking to T, the membrane-spanning tether.

5. The compound of claim 4, wherein R¹ is —CH₂CH(OH)CH₂N⁺(CH₃)₂(CH₂CH₂OH); —(CH₂)₃ SO₃⁻; —(CH₂)₄SO₃⁻; —(CH₂)₃—N⁺(R⁸)₃ wherein each occurrence of R⁸ is independently C₁-C₆ alkyl or C₁-C₄—SO₃⁻; —(CH₂)₂—N⁺(R⁹)₃ wherein each occurrence of R⁹ is independently C₁-C₆ alkyl or C₁-C₄—SO₃⁻; or —CH₂CH₂OCH₂CH₂OCH₂CH₂OH.

6. The compound of claim 4, wherein X^{q-} is Br⁻.

7. The compound of claim 4, wherein n is 1.

8. The compound of claim 4, wherein R², R³, R⁴, R⁵, and R⁶ are hydrogen.

9. The compound of claim 4, wherein R^{7a} is methyl.

10. The compound of claim 1, wherein the first chromophore FP is a substituted or unsubstituted cyanine dye fluorophore or derivative thereof, specifically a Cy3, Cy3.5, Cy5, Cy5.5, Cy7, or Cy7.5 derivative.

11. The compound of claim 1, wherein the second chromophore Q has the structure Q-1, Q-2, or Q-3: 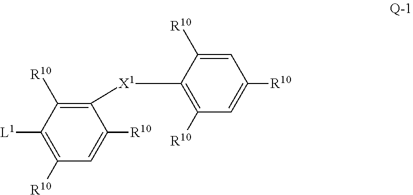
wherein X¹ is N—H or N⁻;
each R¹⁰ is hydrogen or —NO₂, specifically —NO₂; and
L¹ is a group linking to T, the membrane-spanning tether; 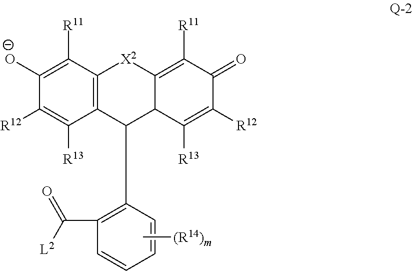
wherein X² is absent, O, S, or Si(CH₃)₂;
R¹¹ is H, Br, Cl, or I;
each R¹² and R¹³ independently is H, Br, Cl, NO₂, or I, or R¹² and R¹³ together form a divalent —CH═CH—CH═CH— group;
R¹⁴ is H, C₁-C₁₀ alkyl, halogen, C₁-C₁₀ alkoxy, C₆-C₁₂ aryl, C₃-C₁₀ cycloalkyl, C₁-C₁₀ alkylthio, or C₁-C₁₀ haloalkyl; m is 0, 1, or 2; and
L² is a group linking to T, the membrane-spanning tether of Formula (1); 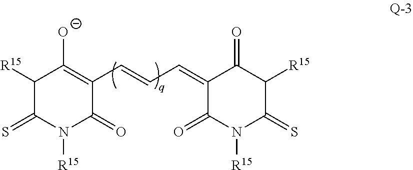
wherein q is 0, 1, or 2;
each R¹⁵ is independently C₁-C₁₂ alkyl, H, Br, Cl, I or NO₂ with the proviso that one R¹⁵ is L³ a group linking to T, the membrane-spanning tether of Formula (1).

12. The compound of claim 11, wherein every instance of R₁₀ is —NO₂.

13. The compound of claim 11, wherein
L¹ is a bond, an amide group, an ether group, a carbamate group, a carbonate group, a substituted or unsubstituted carbohydryl chain, or a combination thereof,
L² is a bond, an amide group, an ether group, a carbamate group, a sulfonate group, a carbonate group, a substituted or unsubstituted C₁-C₁₀ carbohydryl chain, or a combination thereof; and
L³ is a bond, an amide group, an ether group, a carbamate group, a sulfonate group, a carbonate group, a substituted or unsubstituted C₁-C₁₀ carbohydryl chain, or a combination thereof.

14. The compound of claim 1, wherein the second chromophore Q is a bromocresol derivative.

15. The compound of claim 1, wherein the membrane-spanning tether T comprises about 29 to about 35, specifically about 30 to about 34, more specifically about 31 to about 33, and yet more specifically about 32 linker atoms in length, wherein each linker atom may be a carbon, oxygen, or nitrogen.

16. The compound of claim 1, wherein the membrane-spanning tether T comprises about 0 to about 6 ether groups, specifically about 2 to about 4 ether groups; about 0 to about 6 amide groups, specifically about 2 to about 4 amide groups; about 0 to about 6 polyethylene glycol groups, specifically about 2 to about 4 polyethylene glycol groups; or a combination thereof.

17. The compound of claim 1, wherein the membrane-spanning tether T is
—(CH₂CH₂O)₂CH₂CH₂NH(C═O)—(CH₂)₁₁—NH(C═O)CH₂—(OCH₂CH₂)₂—NH(C═O)—CH₂CH₂—;
—(CH₂)₁₂—NH(C═O)—(CH₂)₁₁—NH(C═O)CH₂—(OCH₂CH₂)₂—NH(C═O)—CH₂CH₂—; or
—(CH₂)₁₂—NH(C═O)—(CH₂)₁₁—NH(C═O)—CH₂CH₂—.

18. The compound of claim 1, which is a compound from Table 1, herein.

19. A method for
ion channel drug screening,
screening drugs for cardiac toxicology,
non-invasive imaging of electrical activity in human brain and heart,
photoacoustic imaging for recording electrical activity deep in tissues, or a combination thereof comprising
using one or more of the compounds of claim 1.
